(19) United States
(12) Patent Application Publication
(10) Pub. No.: US 2018/0053268 A1
(43) Pub. Date: Feb. 22, 2018

(54) METHOD AND SYSTEM FOR PROVISIONING PRODUCTS AND/OR SERVICES FOR REAL ESTATE PROPERTIES

(71) Applicant: The Energy Link, LLC, Marietta, GA (US)

(72) Inventor: Darren M. Novich, Marietta, GA (US)

(21) Appl. No.: 15/439,083

(22) Filed: Feb. 22, 2017

Related U.S. Application Data
(60) Provisional application No. 62/298,100, filed on Feb. 22, 2016.

(51) Int. Cl. G06Q 50/16; G06Q 30/08; G06Q 30/06

(52) U.S. Cl. CPC G06Q 50/16; G06Q 30/0641; G06Q 30/08

(57) ABSTRACT

Disclosed are methods and systems for facilitating provisioning of products and/or services for real estate properties. Accordingly, an online platform accessible to users such as property owners, property managers, vendors, contractors and suppliers. The online platform may be configured to present, using a processor, a user interface including indication of one or more real estate properties. Further, the online platform may be configured to receive, using a processor, a selection from a user of at least one of a product and a service corresponding to the one or more real estate properties. Further, the online platform may be configured to the generation and lifecycle management of RFPs. Furthermore, the online platform may be configured to present, using a processor, an indication of at least one supplier of at least one of the product and the service based on the selection. Accordingly, information such as bids and bid terms provided by suppliers may be presented to property owners or property managers.

### RELATED APPLICATION

Applicant claims the benefit of U.S. provisional application No. 62/298,199, filed on Feb. 22, 2016, which is incorporated herein by reference. It is intended that each of the referenced applications may be applicable to the concepts and embodiments disclosed herein, even if such concepts and embodiments are disclosed in the referenced applications with different limitations and configurations and described using different examples and terminology

### BACKGROUND

The present disclosure generally relates to provisioning of products and/or services for real estate properties.

### BACKGROUND

Conventionally, property developers or owners procure products and services for real estate properties by identifying appropriate suppliers and subsequently negotiating a favorable deal. Alternatively, suppliers may be invited to provide respective quotes against a tender and the supplier providing a favorable price may be selected.

However, in the conventional process, buyers such as property developers or owners may not be obtaining the best deals possible. For example, buyers may not be in possession of current market information such as price trends in order to make an informed decision in accepting a supplier's quote.

Moreover, in the conventional process, the life cycle of a procurement including various stages of interaction between the buyer and one or more suppliers may be spread across different computer systems and in some cases may be solely on paper. For example, the life cycle may include stages such as bidding, budgeting, contract management and project management. Accordingly, tracking and management of a procurement by either the buyer or the supplier may be cumbersome, especially in cases where large number of real estate properties are involved.

Therefore, there is a need for improved methods and systems for facilitating provisioning of products and/or services corresponding for real estate properties.

### BRIEF OVERVIEW

A method and system for provisioning products and/or services for real estate properties may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure describes an online platform to facilitate provisioning of products and/or services to large property owners such as, for example, property management companies, property owners and property developers. The products may include, for example, utilities such as electric power, natural gas and water. Further, the services may include, for example, repair work, electric cabling, plumbing, lighting, and so on.

The online platform may be accessed by one or more entities such as property managers, suppliers of the products and/or services and contractors. Further, the online platform may facilitate interaction amongst the one or more entities. For example, the interactions may include various stages of a procurement life cycle such as, bidding, execution of a contract and project management.

For example, the online platform may be configured to present a list of real estate properties corresponding to a platform user, such as a property owner or a property manager.

Further, data associated with the list of real estate properties such as, but not limited to, name, legal name, address and contracts may be populated and presented to the platform user. Accordingly, the platform user may be able to view information such as contracts currently associated with a real estate property, supplier information, cost information and expiration of the contract.

Additionally, the platform user may be presented with a user interface to enable selection of one or more suppliers corresponding to a real estate property. Further, the user interface may also be configured to allow the platform user to add an existing contract with a supplier in relation to a real estate property.

Further, the online platform may enable one or more entities such as suppliers, vendors and contractors associated with the products and/or services to place bids for provisioning the products and/or services in relation to the real estate properties. Accordingly, the online platform may present a user interface in order to allow the one or more entities to place the bids. As a result, the online platform encourages the one or more entities to win contracts for big property managers by providing lower rates, similar in concept to a wholesale or aggregate based pricing. Accordingly, the platform user may be enabled to view accept the bids placed on the online platform.

Furthermore, in order to help the platform user such as a property owner or a property manager to make an educated decision on selecting a bid, the online platform may be configured to provide trends in pricing in relation to the products and/or services.

Further, in case the provisioning relates to a project as opposed to a commodity, the online platform may be configured to provide a project management tool.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure.

FIG. 2 illustrates a properties view of an online platform for provisioning products and/or services for real estate properties in accordance with various embodiments.

FIG. 3 illustrates a property details view of an online platform for provisioning products and/or services for real estate properties in accordance with various embodiments.

FIG. 4A illustrates a contracts view of an online platform for provisioning products and/or services for real estate properties in accordance with various embodiments.

FIG. 4B illustrates a supplier scorecard in accordance with various embodiments.

FIG. 5 illustrates a bids view of an online platform for provisioning products and/or services for real estate properties in accordance with various embodiments.

FIG. 6 illustrates a market trends view of an online platform for provisioning products and/or services for real estate properties in accordance with various embodiments.

FIG. 7 illustrates a sustainability projects view of an online platform for provisioning products and/or services for real estate properties in accordance with various embodiments.

FIG. 8A illustrates an overview view of an online platform for provisioning products and/or services for real estate properties in accordance with various embodiments.

FIG. 8B illustrates an overview view of an online platform for provisioning products and/or services for real estate properties in accordance with various embodiments.

FIG. 9A illustrates a dashboard view of an online platform for provisioning products and/or services for real estate properties in accordance with various embodiments.

FIG. 9B illustrates a dashboard view of an online platform for provisioning products and/or services for real estate properties in accordance with various embodiments.

FIG. 10 illustrates a preferences view of an online platform for provisioning products and/or services for real estate properties in accordance with various embodiments.

FIG. 11 illustrates a budget view of an online platform for provisioning products and/or services for real estate properties in accordance with various embodiments.

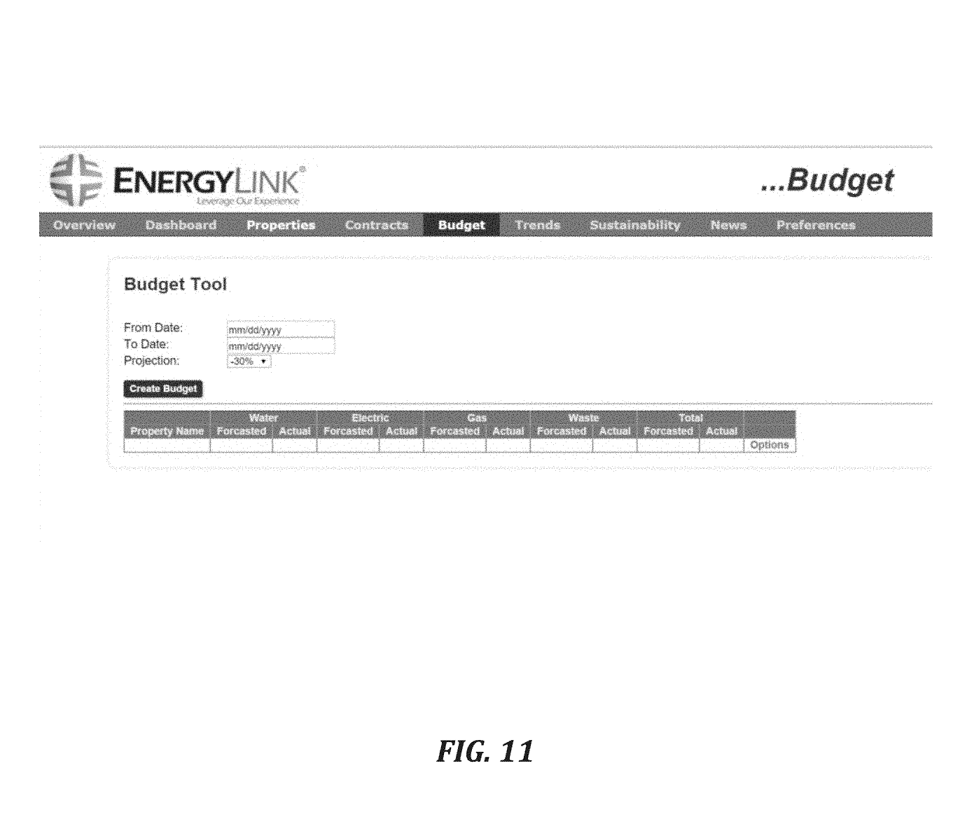

FIG. 12 is a flow chart of a method of provisioning products and/or services for real estate properties in accordance with various embodiments.

FIG. 13 is a block diagram of a system including a computing device for performing the method of FIG. 12.

FIG. 14 illustrates a listing of user types compatible with various embodiments.

FIG. 15A illustrates a customer view of an online platform for provisioning products and/or services for real estate properties in accordance with various embodiments.

FIG. 15B illustrates a customer view of an online platform for provisioning products and/or services for real estate properties in accordance with various embodiments.

FIG. 16A illustrates a supplier view of an online platform for provisioning products and/or services for real estate properties in accordance with various embodiments.

FIG. 16B illustrates a supplier view of an online platform for provisioning products and/or services for real estate properties in accordance with various embodiments.

FIG. 16C illustrates a supplier view of an online platform for provisioning products and/or services for real estate properties in accordance with various embodiments.

FIG. 17 illustrates a dashboard view of an online platform for provisioning products and/or services for real estate properties in accordance with various embodiments.

FIG. 18A illustrates a request for proposal view of an online platform for provisioning products and/or services for real estate properties in accordance with various embodiments

FIG. 18B illustrates a request for proposal overview view of an online platform for provisioning products and/or services for real estate properties in accordance with various embodiments.

FIG. 19 illustrates a request for proposal generation overview view of an online platform for provisioning products and/or services for real estate properties in accordance with various embodiments.

FIG. 20 illustrates a request for proposal edit view of an online platform for provisioning products and/or services for real estate properties in accordance with various embodiments.

FIG. 21 illustrates a request for proposal review view of an online platform for provisioning products and/or services for real estate properties in accordance with various embodiments.

FIG. 22 illustrates a request for proposal review data preview view of an online platform for provisioning products and/or services for real estate properties in accordance with various embodiments.

FIG. 23 illustrates a request for proposal transmit view of an online platform for provisioning products and/or services for real estate properties in accordance with various embodiments.

FIG. 24 illustrates a request for proposal bid intake view of an online platform for provisioning products and/or services for real estate properties in accordance with various embodiments.

FIG. 25 illustrates a request for proposal bid intake data preview view of an online platform for provisioning products and/or services for real estate properties in accordance with various embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of provisioning products and/or services for real estate properties, embodiments of the present disclosure are not limited to use only in this context.

I. Platform Overview

Consistent with embodiments of the present disclosure, a method and system for provisioning products and/or services for real estate properties may be provided. This overview is provided to introduce a selection of concepts in a simplified form that are further described below. This overview is not intended to identify key features or essential features of the claimed subject matter. Nor is this overview intended to be used to limit the claimed subject matter's scope. The method and system for provisioning products and/or services for real estate properties may be used by individuals or companies to provisioning and procuring commodities and/or services related to real estate properties.

For instance, the online platform may facilitate provisioning of products and/or services to large property owners such as, for example, property management companies, property owners and property developers. Accordingly, in some embodiments, the products and/or services may be procured at a retail pricing based on aggregate usage of the products and/or services at various locations of the real estate properties.

The products may include, for example, utilities such as electric power, natural gas and water. Further, the services may include, for example, repair work, electric cabling, plumbing, lighting, and so on.

The online platform may be accessed by one or more entities such as property managers, suppliers of the products and/or services and contractors. Further, the online platform may facilitate interaction amongst the one or more entities. For example, the interactions may include various stages of a procurement life cycle such as, bidding, execution of a contract and project management.

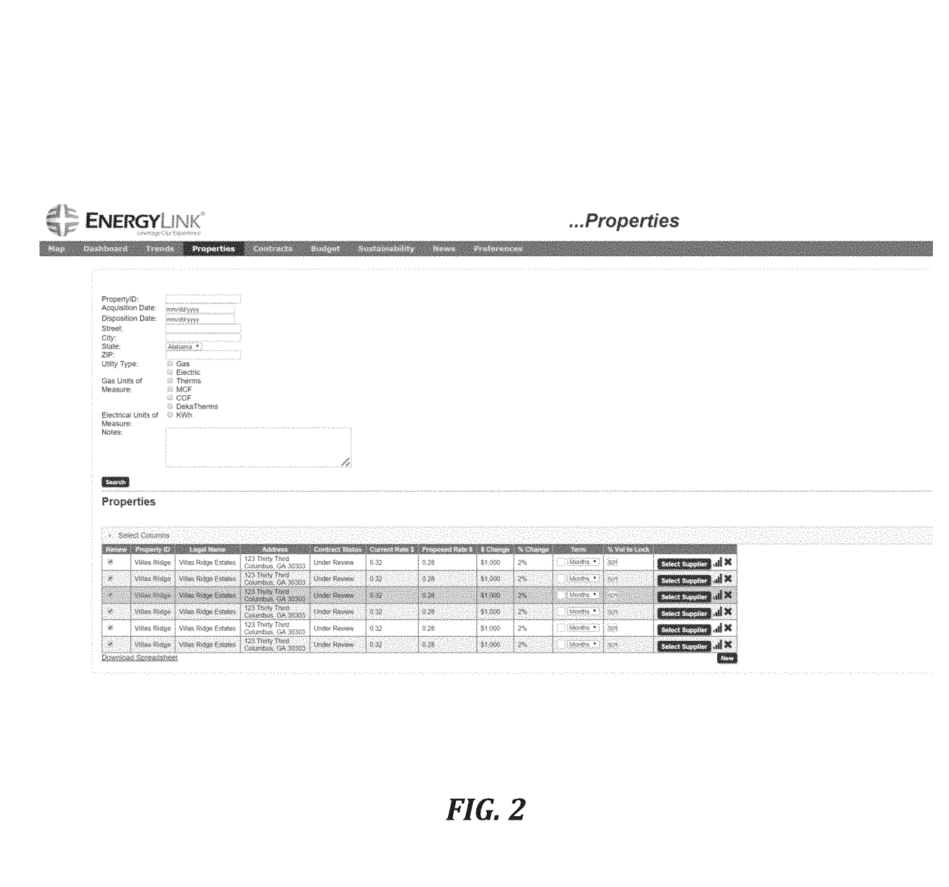

For example, the online platform may be configured to present a list of real estate properties corresponding to a platform user, such as a property owner or a property manager, as illustrated in FIG. 2.

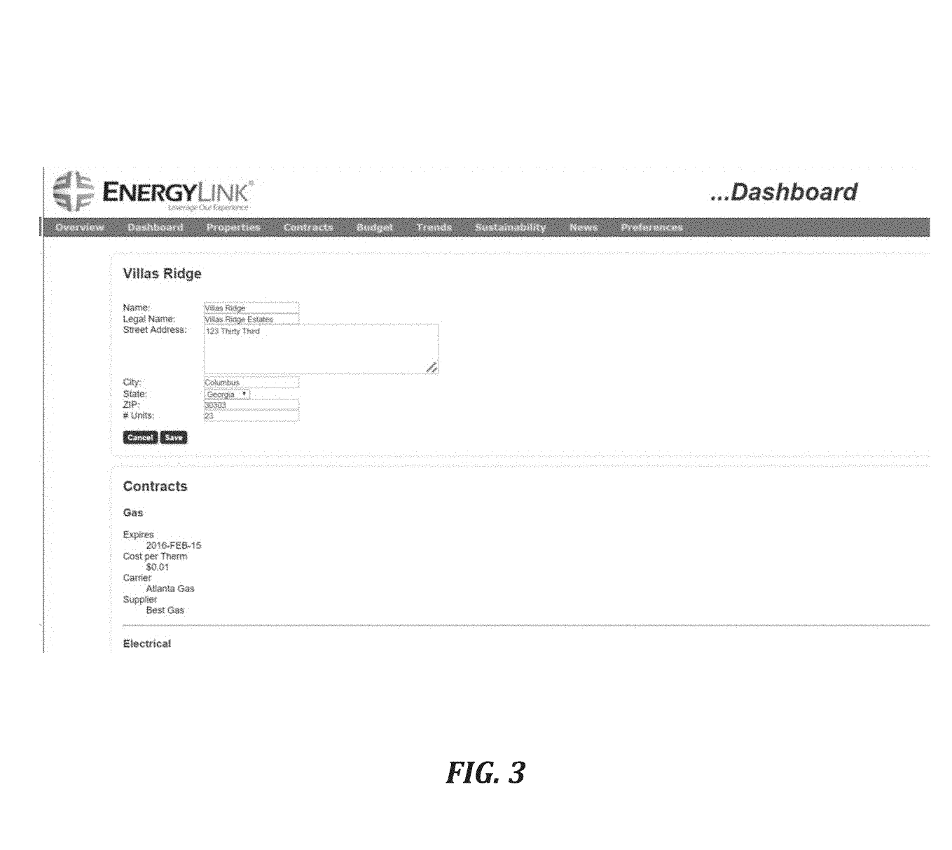

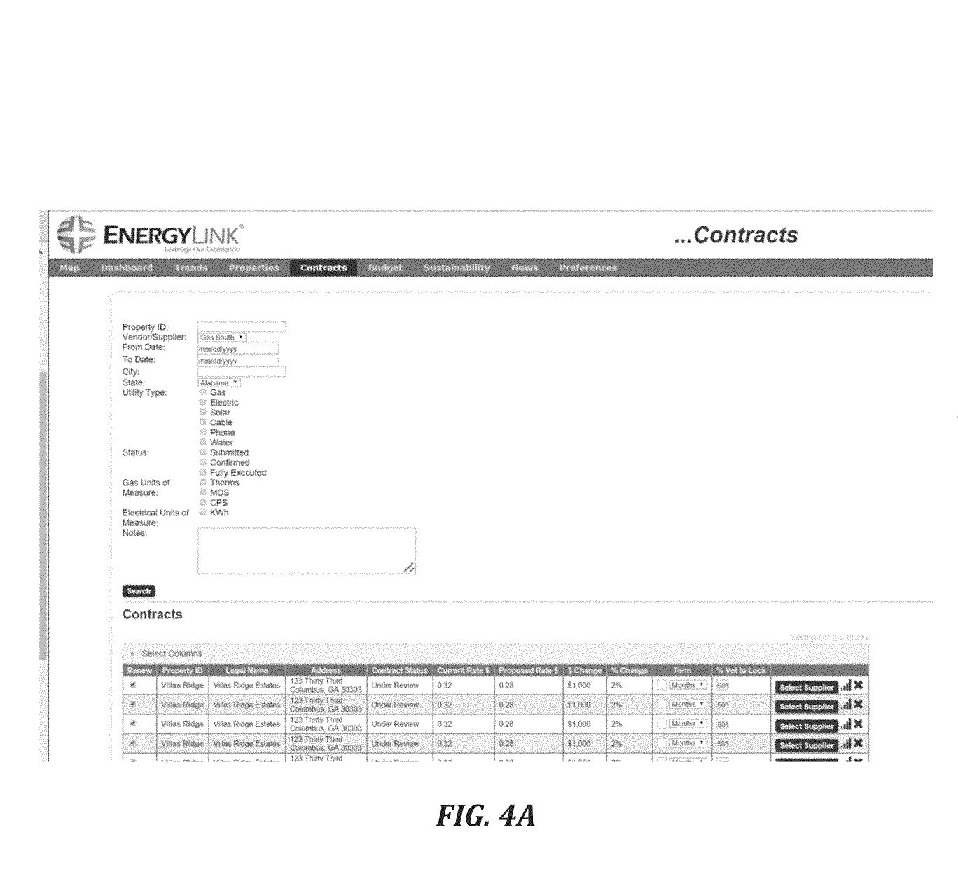

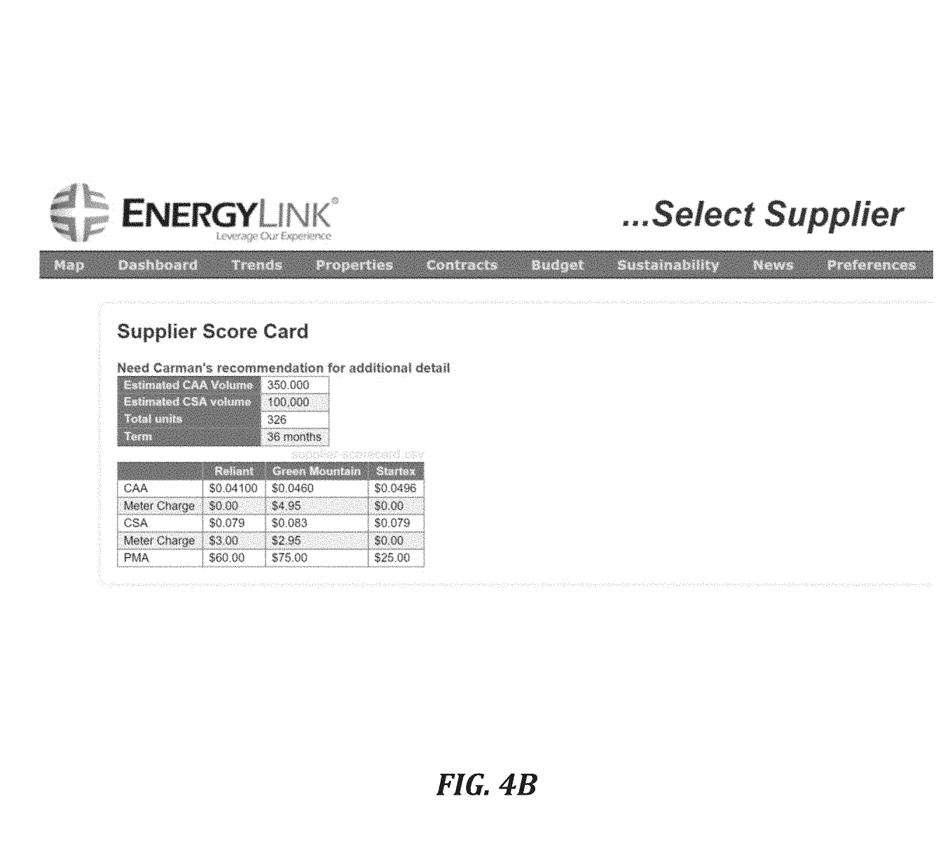

Further, as shown in FIG. 3, data associated with the list of real estate properties such as, but not limited to, name, legal name, address and contracts may be populated and presented to the platform user. Accordingly, the platform user may be able to view information such as contracts currently associated with a real estate property, supplier information, cost information and expiration of the contract as exemplarily illustrated in FIG. 3. Additionally, the platform user may be presented with a user interface to enable selection of one or more suppliers corresponding to a real estate property as illustrated in FIG. 4. Further, the user interface may also be configured to allow the platform user to add an existing contract with a supplier in relation to a real estate property.

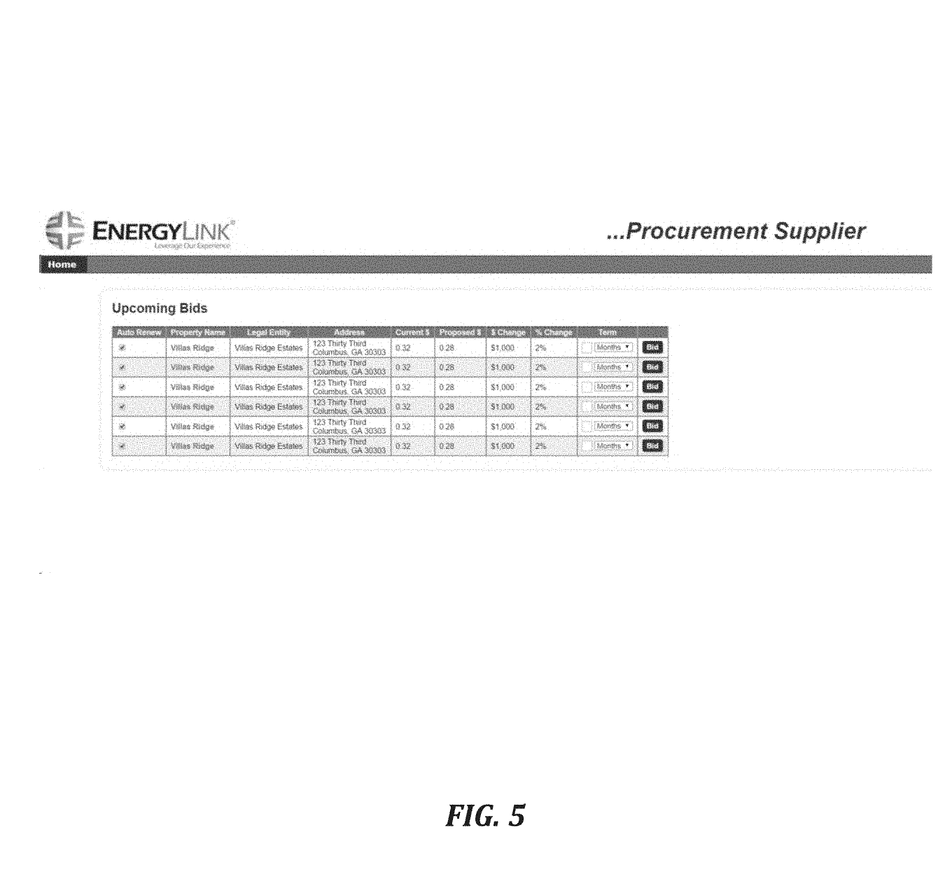

Further, the online platform may enable one or more entities such as suppliers, vendors and contractors associated with the products and/or services to place bids for provisioning the products and/or services in relation to the real estate properties. Accordingly, the online platform may present a user interface as illustrated in FIG. 5 in order to allow the one or more entities to place the bids. As a result, the online platform encourages the one or more entities to win contracts for big property managers by providing lower rates, similar in concept to a wholesale or aggregate based pricing. Further, the platform user may be enabled to view accept the bids placed on the online platform.

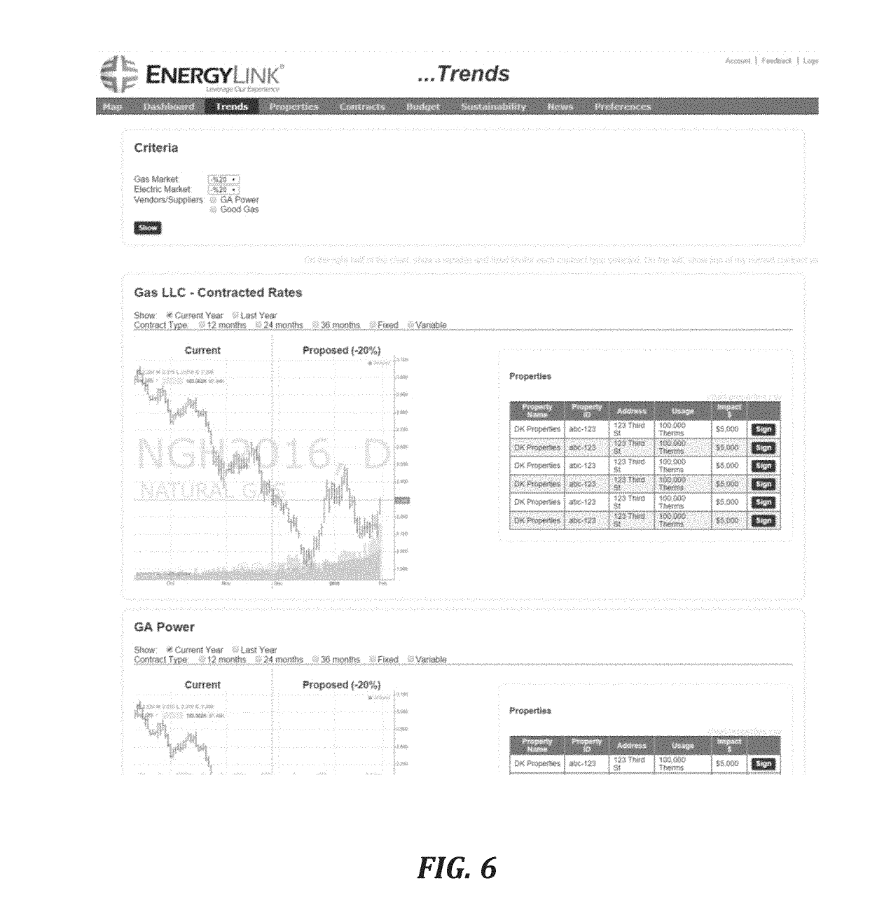

Further, in order to help the platform user such as a property owner or a property manager to make an educated decision on selecting a bid, the online platform may be configured to provide trends in pricing in relation to the products and/or services as exemplarily illustrated in FIG. 6.

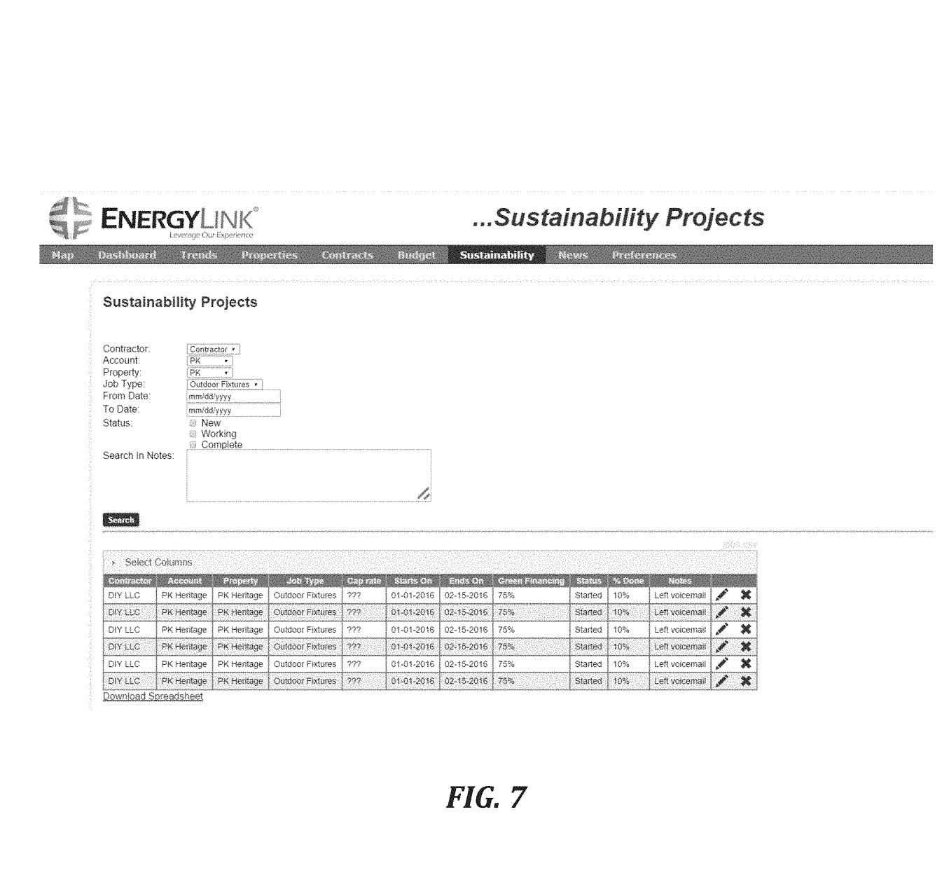

Further, in case the provisioning relates to a project as opposed to a commodity, the online platform may be configured to provide a project management tool as illustrated exemplarily in FIG. 7.

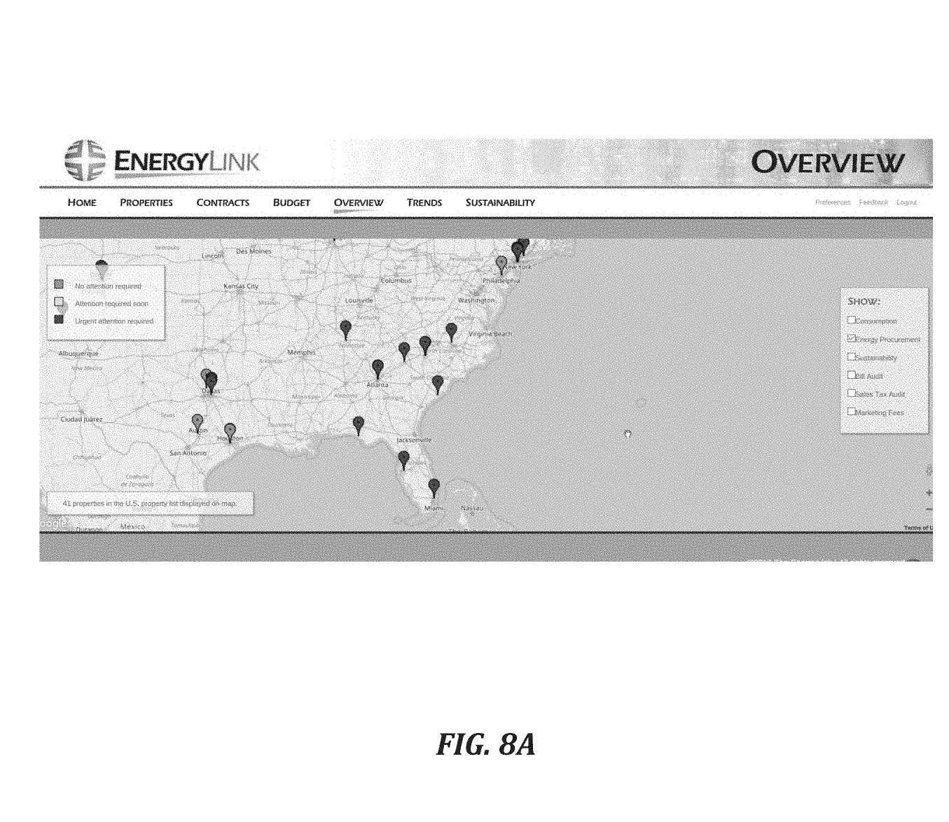

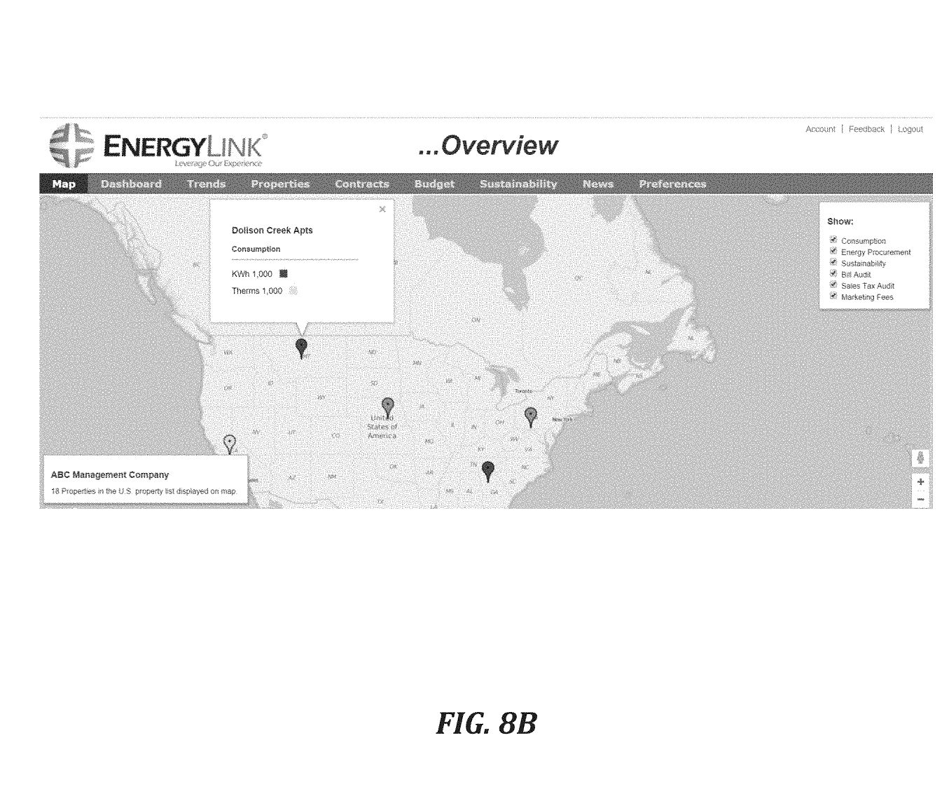

Additionally, in some embodiments, the online platform may be configured to provide a map view as exemplarily illustrated in FIG. 8A. The map view may display all real estate properties associated with the platform user, such as a property manager, over a map based on locations of the real estate properties. Further, the platform user may be enabled to click any Pin and get information about corresponding to real estate properties within the corresponding geographical location. Further, the Pins may be color coded to indicate information related to provisioning of products and/or services. For example, a Pin colored Green may indicate an opportunity for savings. Similarly, a Pin colored Red may indicate no savings opportunity. Such may be the case when the market rates are higher than rates in the contract. Likewise, a Pin colored Yellow may indicate that more information is needed or that calculations are not yet performed. The following categories may be displayed on the map:
Consumption of Energy
   Consumption Exceed Forecast Threshold
Energy Procurement
   Contract Expiration Alert
Sustainability
   Reducing Energy Consumptions
      Swapping Lighting Features
      Adding Solar Panels and other Alternative/Clean Energy Supplies
      The “Green Aspect” of the properties
   Issues with Current Projects or Opportunities for Future Projects
Bill Audit
   Is the Property Properly Classified According to Rates?
   Is the Customer Being Charged Properly?
Sales Tax Audit
   Is company in proper compliance with Utility Tax rules in the state?
Marketing Fees
   Continued Service Agreement (CSA)—steers consumers towards a given utility, if that happens, Customer gets $50/95 per unit sold
   A commission Opportunity
   An opportunity to save money

Further, hovering a mouse pointer over a Pin may display information about an area corresponding to the geolocation of the Pin. Furthermore, the information may be based on selections made by the platform user on a Legend user interface. Still consistent with embodiments, alerts may be provided with regard to interruptions and curtailments issued by suppliers. These alerts may be presented in various view, including but not limited, map views and dashboard views.

In some embodiments, the online platform may be configured to provide action notification in key areas, such as energy consumption, energy consumption exceeding a forecast threshold, reductions in energy consumption, energy procurement, contract expiration, sustainability measures, billing and auditing, property classification discrepancies, utility tax rule compliance, and marketing expenditures.

FIG. 8B illustrates the presentation of Consumption information per location. In various embodiments, suppliers of consumed energy may provide the consumer with certain usage tolerances. In such embodiments, the user of the platform may be provided with alerts when consumption nears and/or exceeds those tolerances. Additional information associated with power consumption may be provided with reference to the Sustainability section as illustrated in FIG. 7B.

For example, when property managers improve aspects of their sustainability, the power usage may begin to drop below their agreed upon contracted volumes. Such information may be presented in the sustainability section of the platform. Sustainability projects may be tracked as further presented in FIG. 7B. The information conveyed to the user in this section may include, but not be limited to, project dates, types, financing, rebates, project status details and the like.

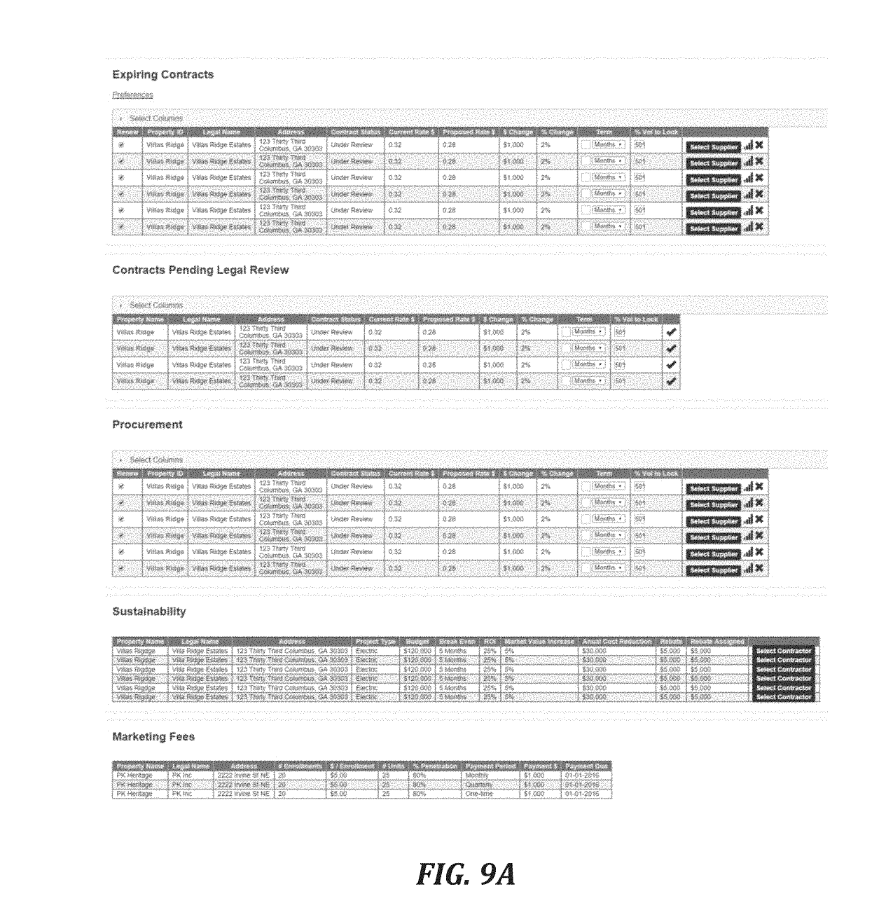

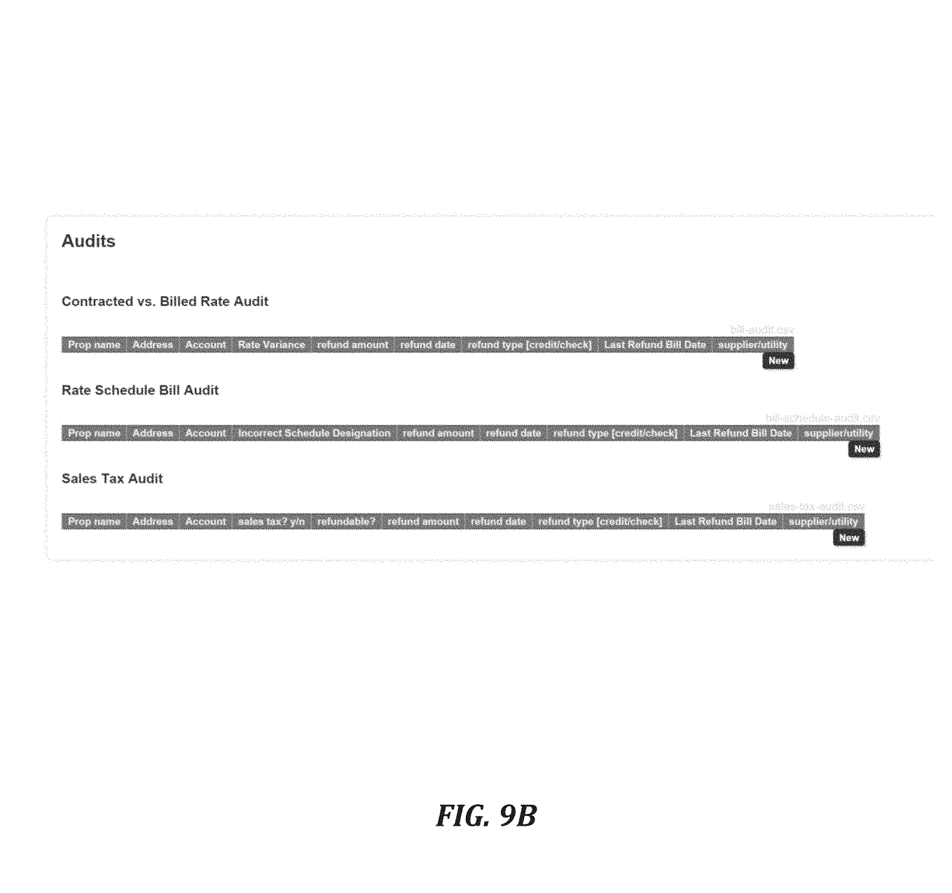

Additionally, the online platform may be configured to present a dashboard view to the platform user as exemplarily illustrated in FIG. 9. The dashboard view may provide an overview of all information associated with provisioning of products and/or services for the real estate properties.

For instance, the dashboard view may display information regarding Expiring Contracts as illustrated in FIG. 9A. Accordingly, the platform user may be enabled to renew contracts. Additionally, the dashboard view may display information regarding energy procurement such as current rates, proposed rates, changes in rates and supplier list. FIG. 9B illustrates an audit functionality consistent with embodiments of the present disclosure.

Further, in some embodiments, the online platform may be configured to enable suppliers to provide pricing corresponding to the products and/or services on a continuous basis. Accordingly, suppliers may be provided access to the online platform through a URL. Upon accessing the URL, the supplier may be able to view different real estate properties corresponding to different property managers and subsequently place bids on the rates.

Further, in some embodiments, the list of real estate properties displayed to the supplier may be limited based on one or more criteria. Accordingly, suppliers may be limited in terms of the property managers and/or real estate properties that they may be able to view. Additionally, suppliers may be presented with details regarding historical usage of resources, products and/or services corresponding to the real estate properties in order to entice the suppliers.

Additionally, in some embodiments, the platform user may be a client admin enabled to invite a supplier to the procurement process facilitated by the online platform. Accordingly, the client admin may click “select supplier” option and/or add a new supplier to the list. Subsequently, the supplier added by the client admin may be able to login to the online platform and view the real estate properties associated with a client. As a result, the client may be enabled to engage with suppliers chosen as per the client's preferences.

A system admin may be provided with the following functionality views:

Dashboard
Shows when Contracts are Expiring,
   When it appears here can be controlled in the preferences section
   Properties being Acquired
   Properties being Sold

Customers
Shows portfolio of Customers on System
   Systems they Use
   Contacts they Have
   Properties they Own
   Contracts on Each Properties

Suppliers
Shows list of suppliers for each customer
Shows supplier details, contacts, what utilities they provide, and what market they are in;

Utilities
Has list of utilities, can be filtered by state,
Details include basic utility information, regulation requirements
Shows what commodities severed
Shows what suppliers work with these utilities
Suppliers inputted into the system can be Tied to Utilities

Subsequent to receiving bids from suppliers, the client admin may be able to view the lowest bid and corresponding bid terms in the dashboard view. Further, the client admin may also be able to view bid history of all supplier bids. Accordingly, the client admin may choose to contact a supplier offering a favorable bid and bid terms. Further, the client admin may also be enabled to accept the bid through the online platform. Consequently, the online platform may facilitate a transaction corresponding to the accepted bid.

In some embodiments, the online platform may be further configured to provide sustainability information. For example, the sustainability information may include the opportunities that are available and the corresponding places. Further, the sustainability information may also include indication of a current position of procurements of products and/or services with respect to ROI for a real estate property.

In some embodiments, the online platform may be further configured to provide bill auditing. Accordingly, the platform user may be enabled to review bills associated with vendors, suppliers and/or contractors. Further, the online platform may be configured to perform auditing the bills in order to identify opportunities for provisioning and/or re-provisioning of products and/or services for real estate properties. Further, the identified opportunities may be displayed to one or more entities such as the property owner, property manager, vendor, contractor and supplier.

Additionally, in some embodiments, the online platform may be configured to perform sales tax auditing. Accordingly, based on the billing associated with a real estate property, the online platform may present opportunities for tax savings.

Further, in some embodiments, the online platform may be configured to determine and display marketing fees. Accordingly, the online platform may facilitate the platform user to work with marketing partners.

Further, in some embodiments, the online platform may be configured to present a contracts view as illustrated in FIG. 4A. Accordingly, for a selected real estate property, a list of contracts associated with the real estate property may be determined and displayed. In various embodiments, the % of contracted goods/services may be locked as a ratio of the user's total volume of the corresponding goods/services. In this way, the user need not commit their entire demand for the goods/services to one supplier.

Still consistent with embodiments of the present disclosure, a supplier scorecard may be provided as illustrated in FIG. 4B. In addition to the information illustrated, the supplier scorecard may provide user notes for a particular supplier in addition to historical data associated with the supplier. Each expiring contract may have a scorecard to show you who Bid on the Property and what pricing they provided for winning the expiring contract. The contract can be presented through the system, and then it can be signed through the system. In some embodiments, auto-renewals are also possible.

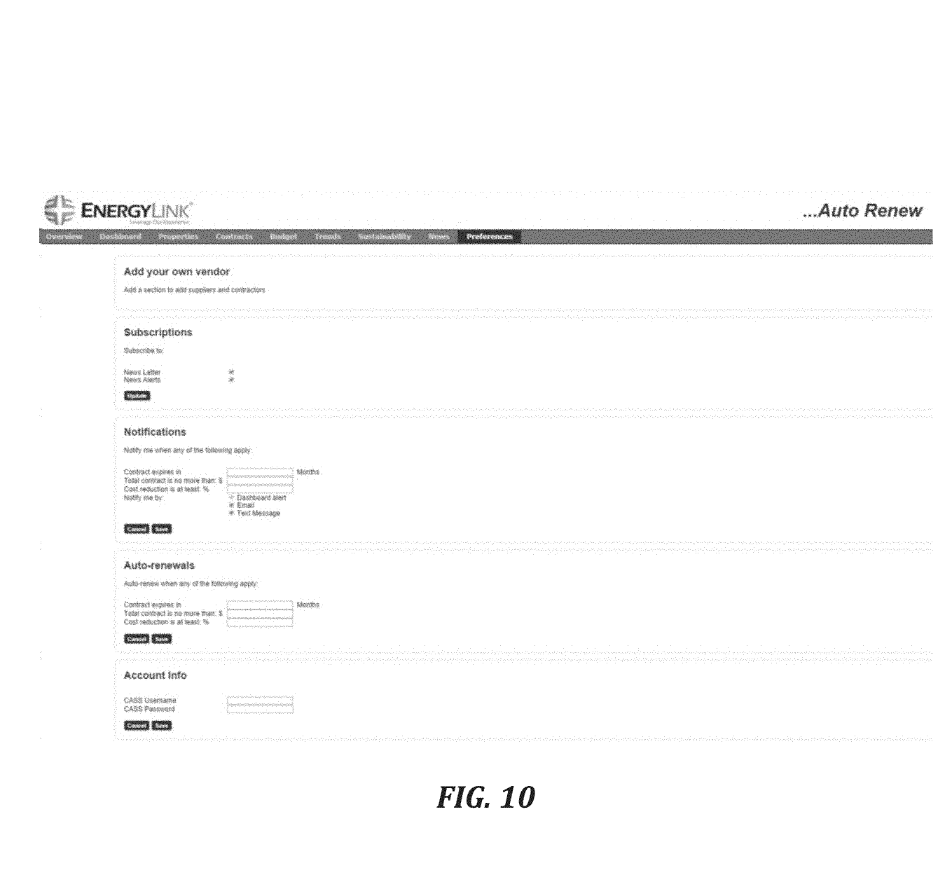

In addition, in some embodiments, the online platform may be configured to present a trends view. When a supplier proposes a bid to a property owner or property manager, the online platform may help the property owner to know if the proposed bid is a good bid. Accordingly, the online platform may access market information and perform statistical analysis of prices and/or bid terms corresponding to products and/or services as exemplarily illustrated in FIG. 6. As a result, the property manager or the property owner may be enabled to make more educated decisions on whether to accept the proposed bid, and under what terms (e.g., contract duration). Accordingly, although a proposed rate may be cheaper than a current rate, the trends view may enable the property manager or property owner to, for example, lock the cheaper rate down for X number of months, because in X+1 months, the rate may be even cheaper. In various embodiments, a user may be enabled to view certain trends and decide to sign the contract based on such trend. Trends may be tied to notifications that a user may set in the preferences page, as illustrated in FIG. 10. In this way, a user may be notified upon a change in a trend as specified.

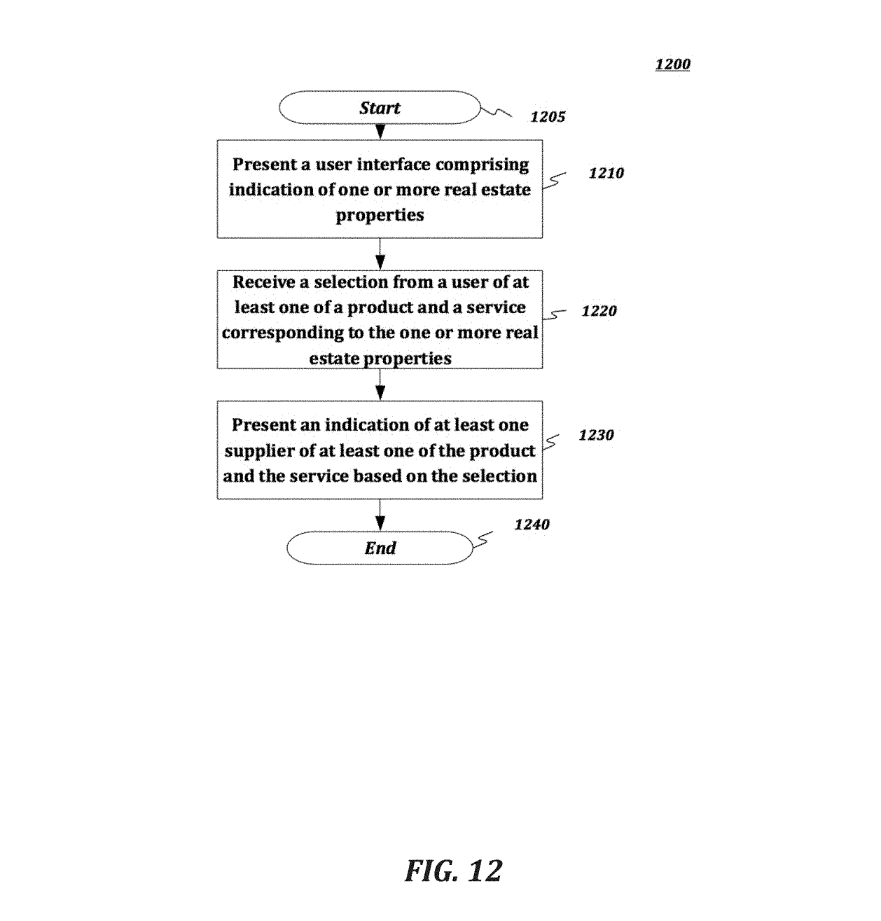

Further, in some embodiments, the online platform may be configured to present a preferences view as illustrated in FIG. 12. The preferences view may, in some embodiments, allow the platform user to add a supplier, vendor and/or a contractor previously known to the platform user. Further, the preferences view may also enable the platform user to add notifications in order to be alerted. Additionally, the platform user may also be enabled to set auto-renewal terms.

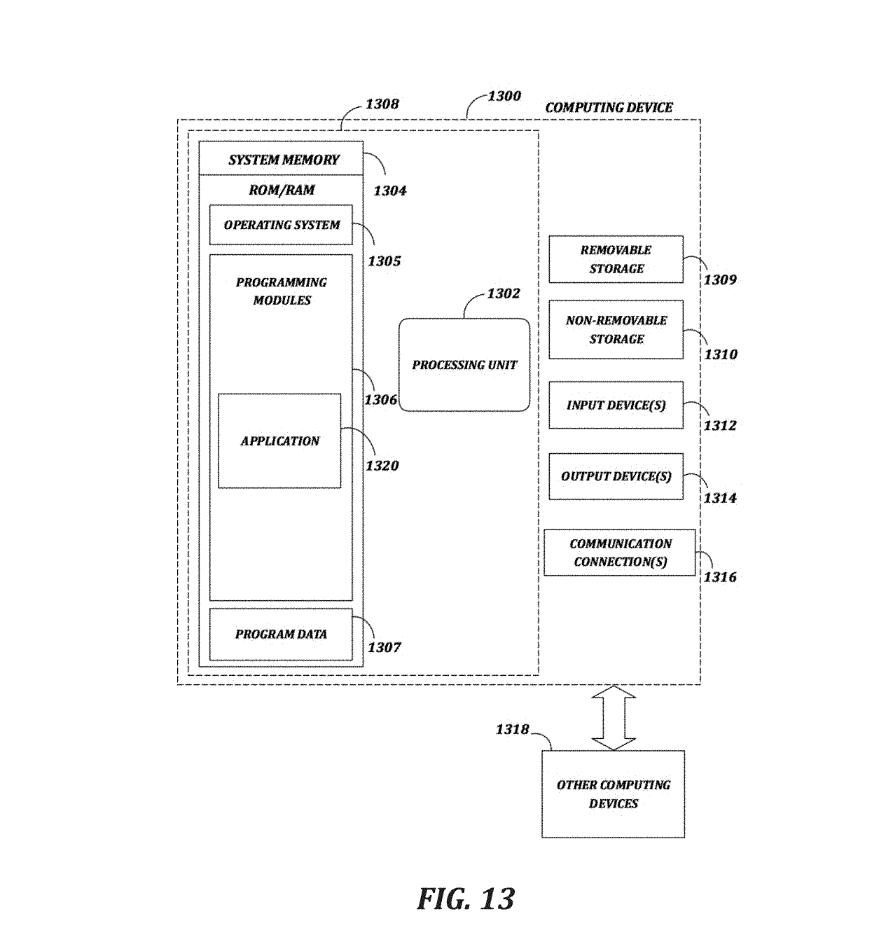

Additionally, in some embodiments, the online platform may be configured to present a budget tool as illustrated in FIG. 13. Accordingly, the platform user, such as a property owner or a property manager may be enabled to create budgetary constraints with regard to products and/or services for a selected real estate property. For instance, as shown, for utilities like water, electricity and natural gas, the platform user may be able to provide one or more of actual requirement and forecasted requirement.

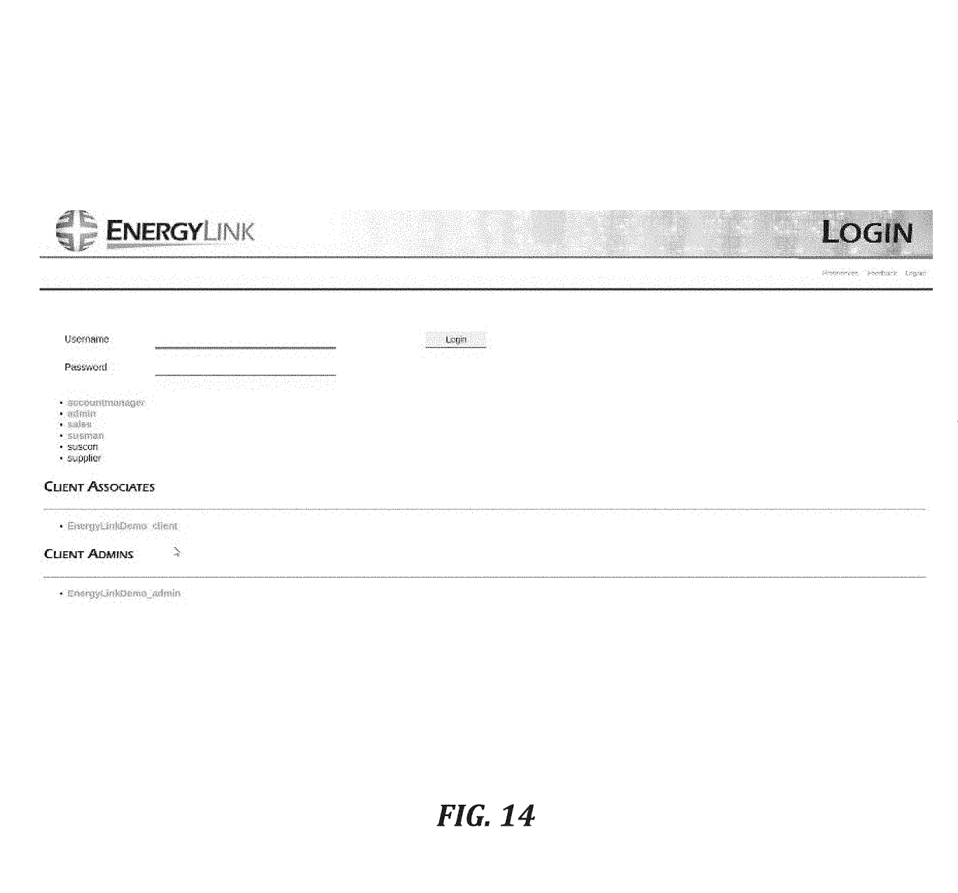

Further, in some embodiments, the online platform may be configured to provide a sustainability view as illustrated in FIG. 14. The sustainability view may facilitate the platform user in project management once contracts are signed. Accordingly, the online platform may present information such as the status of a project and the budget of the project.

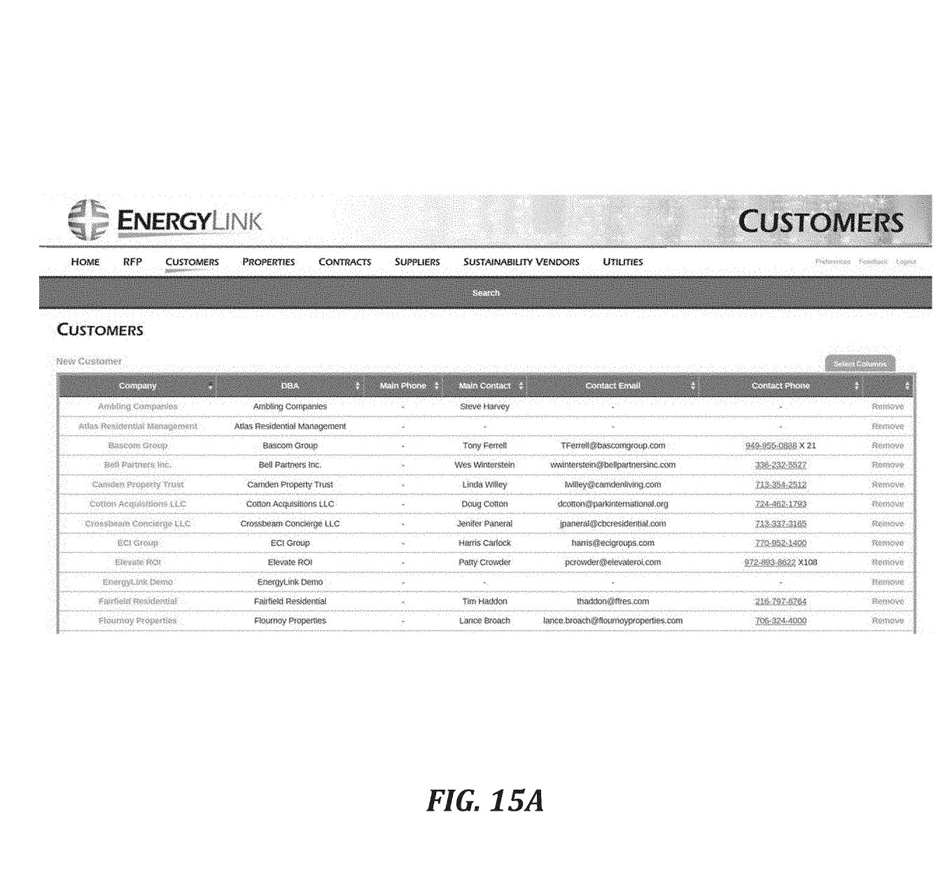

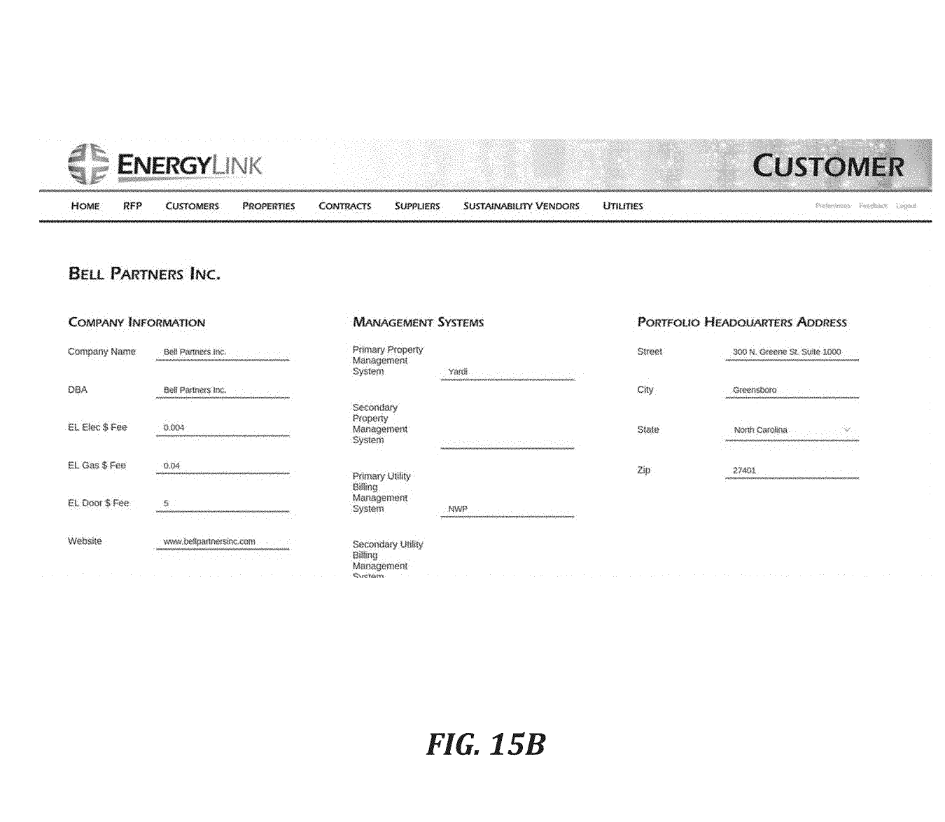

Further, in some embodiments, the online platform may be configured to provide a customer view as illustrated in FIG. 15A. The customer view may facilitate the platform user in customer management. A customer view may also provide an interface that facilitates the management of individual customer information as illustrated in FIG. 15B.

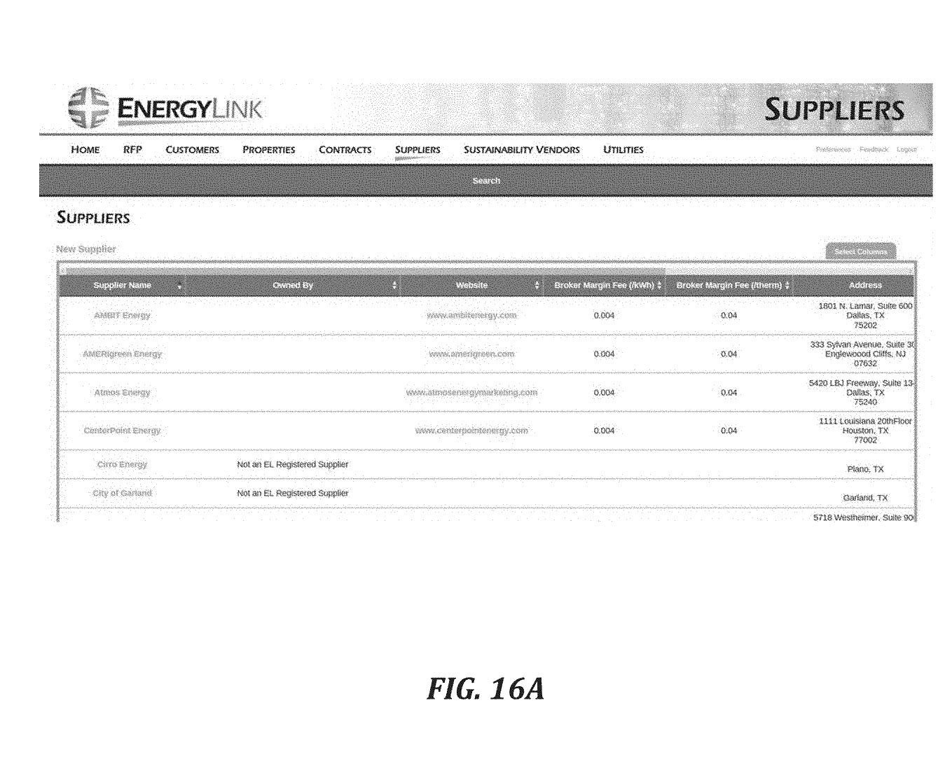

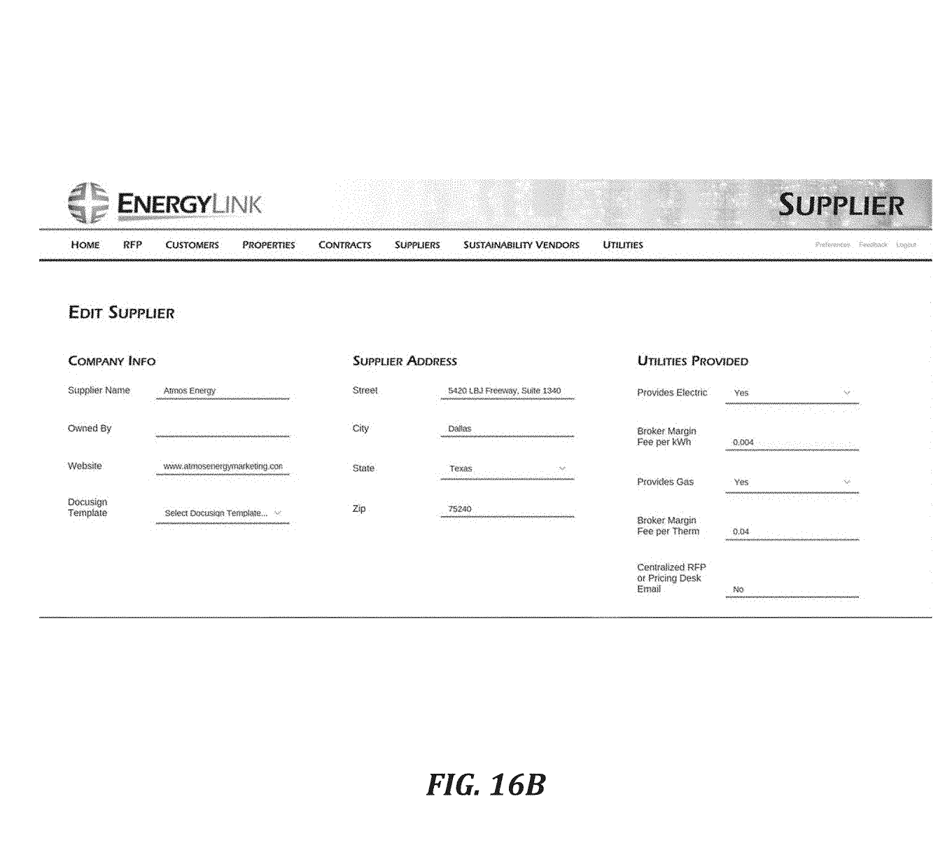

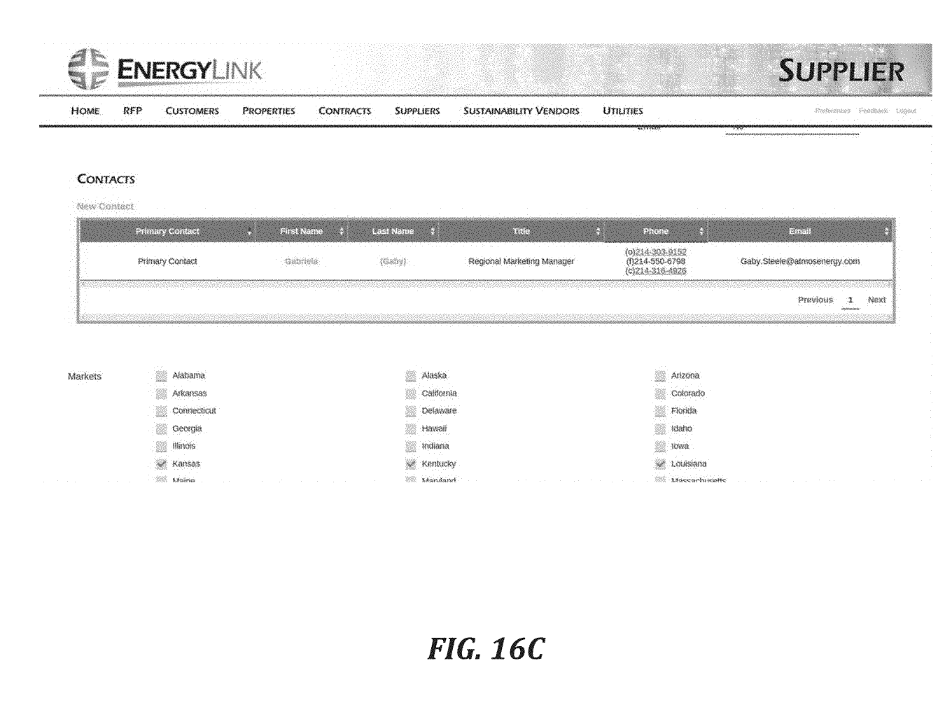

Further, in some embodiments, the online platform may be configured to provide a supplier view as illustrated in FIG. 16A. The supplier view may facilitate the platform user in managing existing and potential suppliers. A supplier view may also provide an interface that facilitates the management of individual supplier information as illustrated in FIG. 16B. A supplier view may also provide an interface that facilitates the management of points of contact for, and markets serviced by, individual suppliers as illustrated in FIG. 16C.

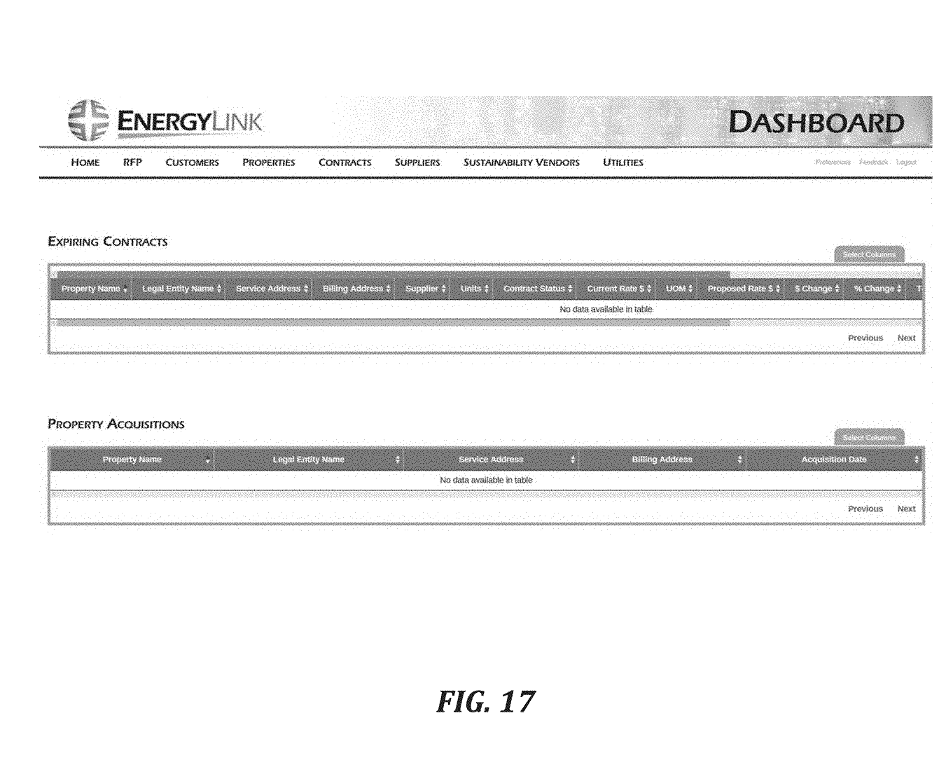

Further, in some embodiments, the online platform may be configured to provide a dashboard view as illustrated in FIG. 17. The dashboard view may provide a platform user with event, alert, or summary information. A dashboard view may facilitate user action on the provided information.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Automated RFP Management System Overview

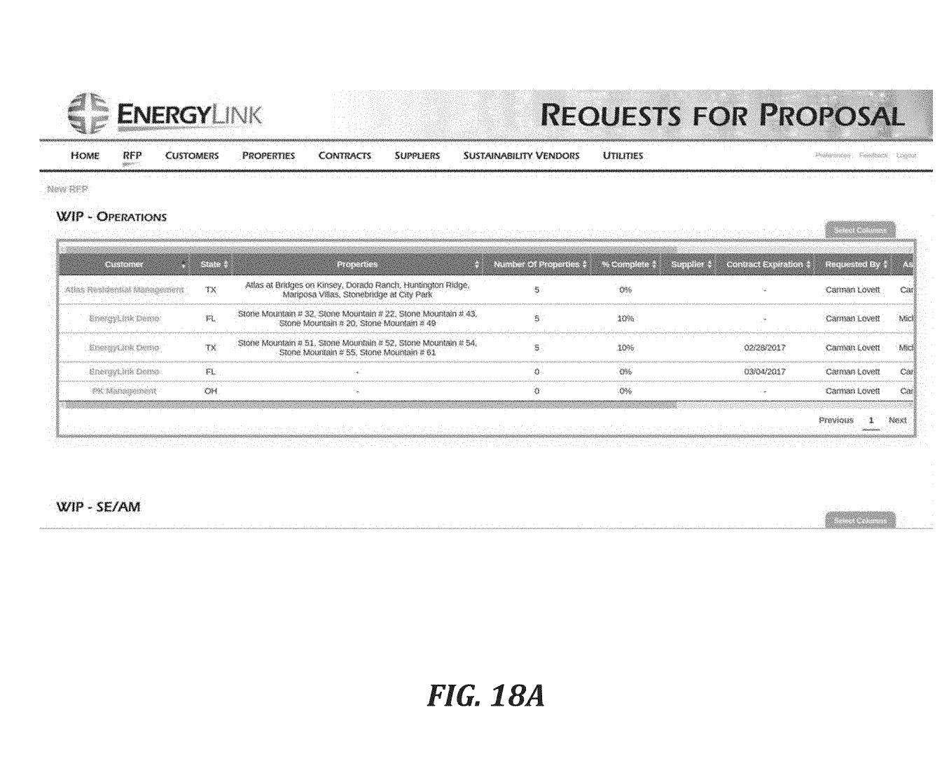

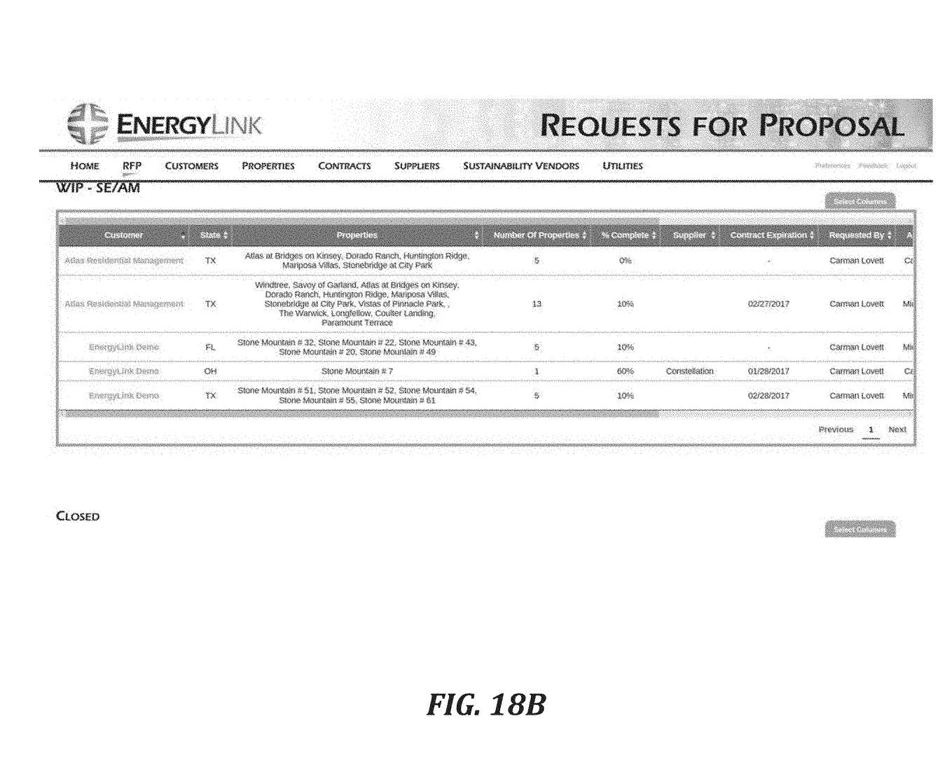

It can be desirable for the online platform to have the capability of managing the lifecycle of request for proposal (RFP) documents. In some embodiments, the online platform may be configured to provide an automated request for proposal management system (ARFPM) as illustrated in FIGS. 18A-B and 19-25. An ARFPM may be configured to provide features such as generating, reviewing, transmitting, receiving, and tracking RFP documents.

In some embodiments, an ARFPM may integrate with, alert a platform user to, or trigger action because of, the temporal proximity of events that may present an RFP opportunity. Such “PFR opportunity events” can include (but are not limited to) ownership changes; property acquisition; an approaching renewal, renegotiation, or termination date; events or actions that trigger a contractual right of termination or withdrawal; government, regulatory, statutory, or case law changes; changes in the ownership, service territory, or competitive landscape of supplier(s); changes in property needs with respect to supplier services; etc.

An ARFPM may be configured to automatically queue and manage the steps involved in an RFP lifecycle. In some embodiments, an ARFPM may have the capability of taking in inputs that include myriad data required for RFP. It may have the capability of generating an RFP, and may further have the capability of allowing a user to modify the RFP. It may further have the capability of transmitting a generated RFP

In some embodiments, the online platform may be configured to provide an RFP overview view as illustrated in FIGS. 18A-B. An RFP overview view may collect, organize, and allow a platform user to take action on RFP data in categories that can include customer, property (list and total-per-customer), revenue, completion status, critical contract date(s), document status, type of contract, commodity, requester/account manager, and others.

An RFP overview view may have an interface that allows the platform user to manage “work in progress” and/or potential (but not yet initiated) RFP data as illustrated in FIG. 18A. A RFP overview view may have an interface that allows the platform user to manage RFP data in a sales executive or account manager queue as illustrated in FIG. 18B.

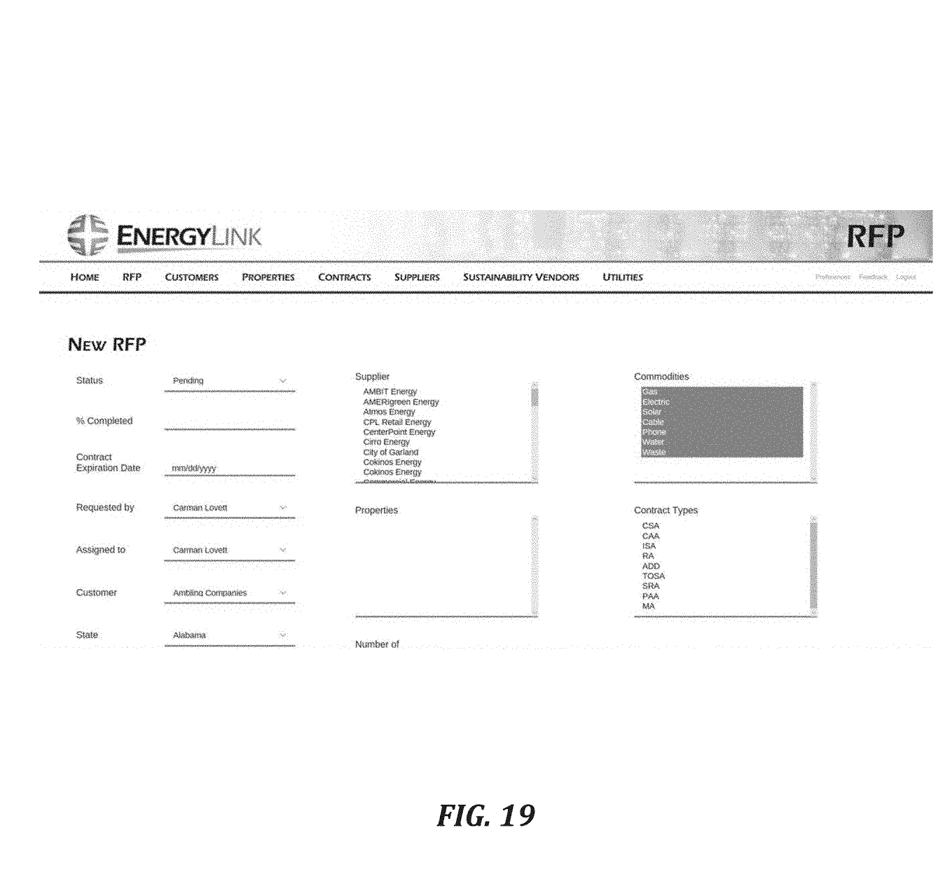

In some embodiments, the online platform may be configured to provide an RFP generation view as illustrated in FIG. 19. An RFP generation view may facilitate the platform user in selecting or inputting details of an RFP.

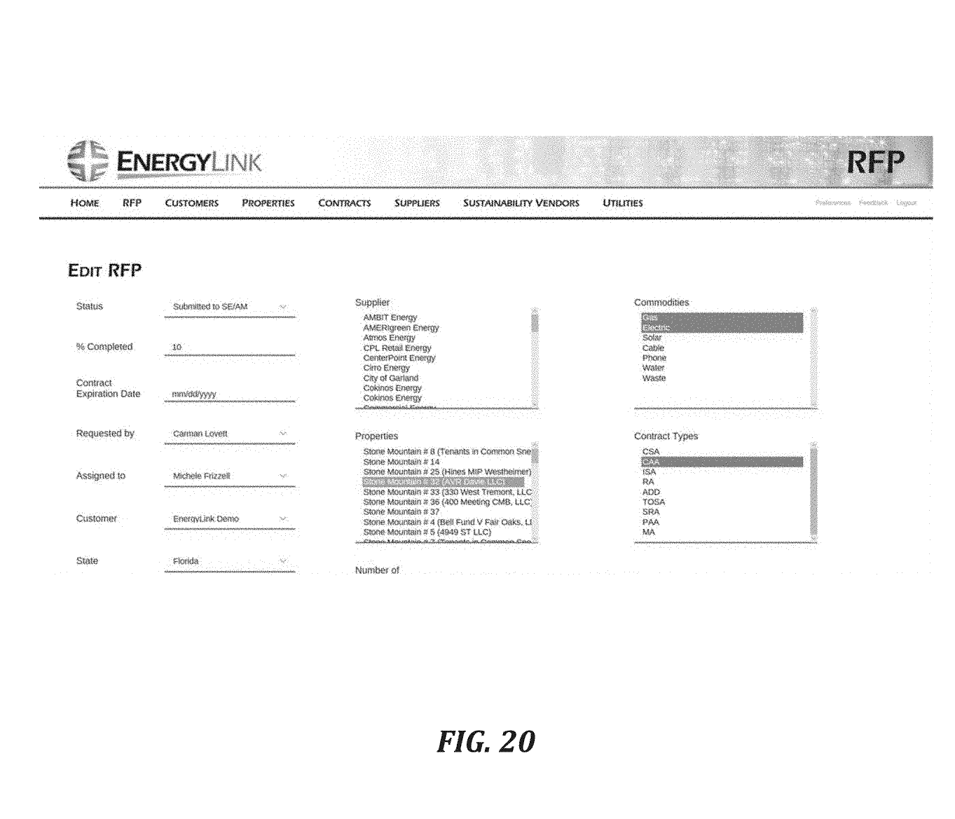

Further, in some embodiments, the online platform may be configured to provide an RFP edit view as illustrated in FIG. 20. An RFP edit view may facilitate the platform user in editing or modifying details of an RFP.

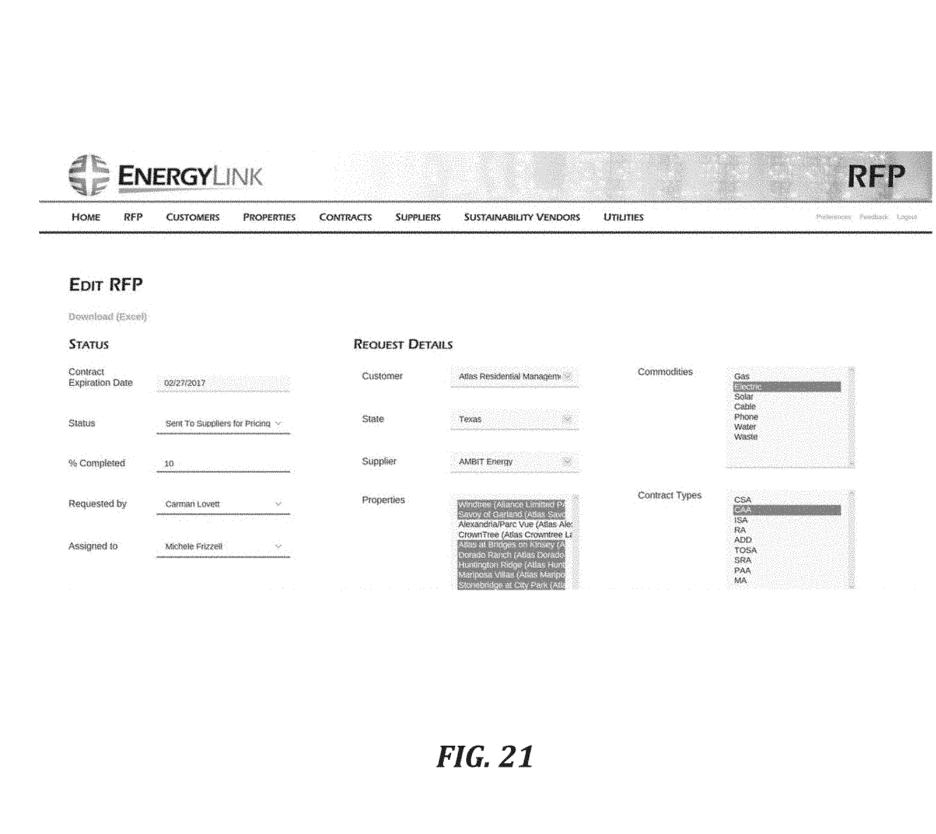

Further, in some embodiments, the online platform may be configured to provide an RFP review view as illustrated in FIG. 21. An RFP review view may facilitate the platform user in editing, modifying, reviewing, or generating a data preview of details of an RFP.

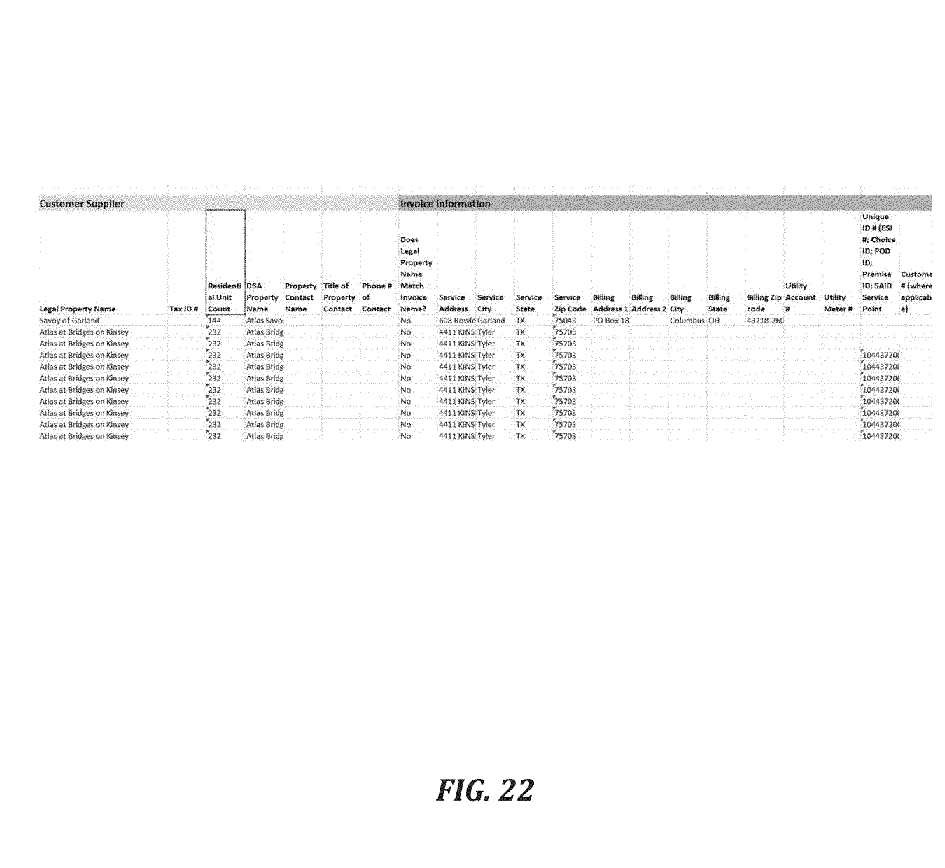

Further, in some embodiments, the online platform may be configured to provide an RFP review data preview view as illustrated in FIG. 22. An RFP review data preview view may facilitate the platform user in reviewing or interacting with the details of an RFP—this may include the capability of interacting with underlying RFP data in a granular way, e.g. with individual data-points.

An RFP review data preview view can be browser-based (as with database data supplied to a platform user via a web interface), or it can be a downloadable file in spreadsheet (e.g. CSV, Microsoft Excel), database (e.g. SQL MDF, Microsoft ACCDB), list, graphical, proprietary or open-standard data object, or other format.

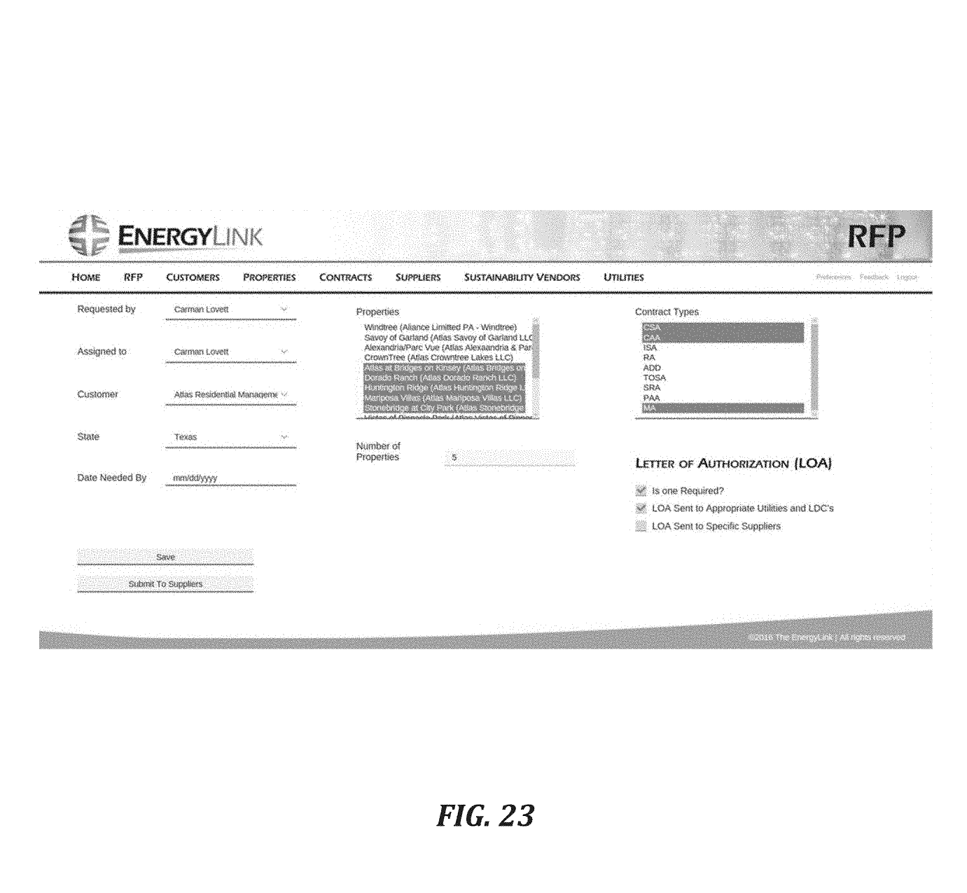

Further, in some embodiments, the online platform may be configured to provide an RFP transmit view as illustrated in FIG. 23. An RFP transmit view may facilitate the platform user in pre-transmit review and selection actions, and transmitting a final generated RFP to one or more suppliers.

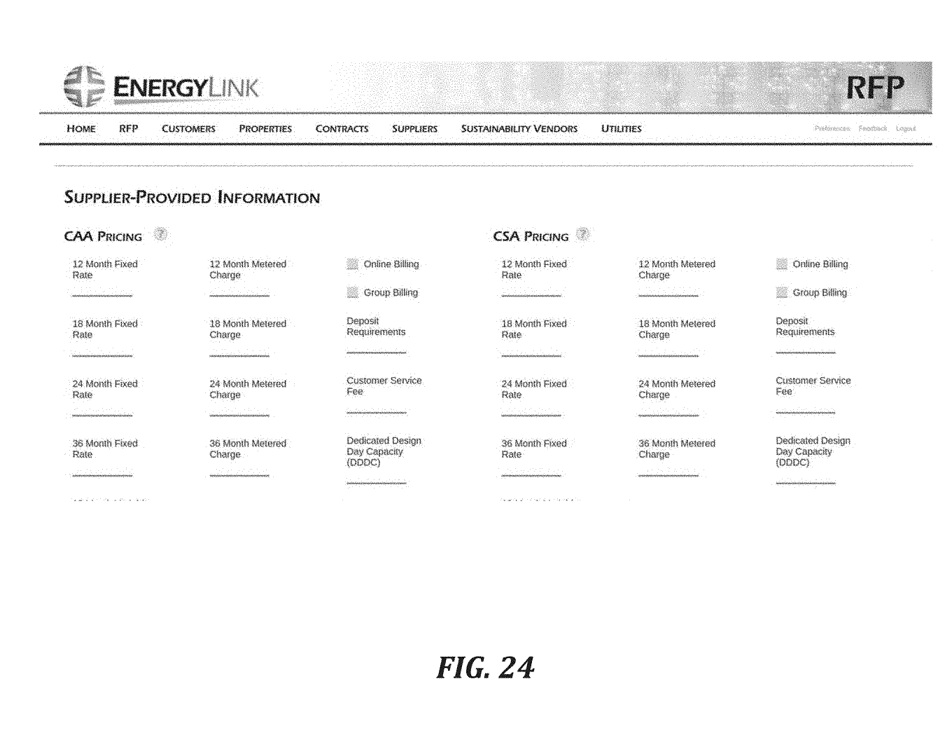

Further, in some embodiments, the online platform may be configured to provide an RFP bid intake view as illustrated in FIG. 24. An RFP bid intake view may facilitate the platform user in reviewing the status and details of bids received from suppliers for RFPs.

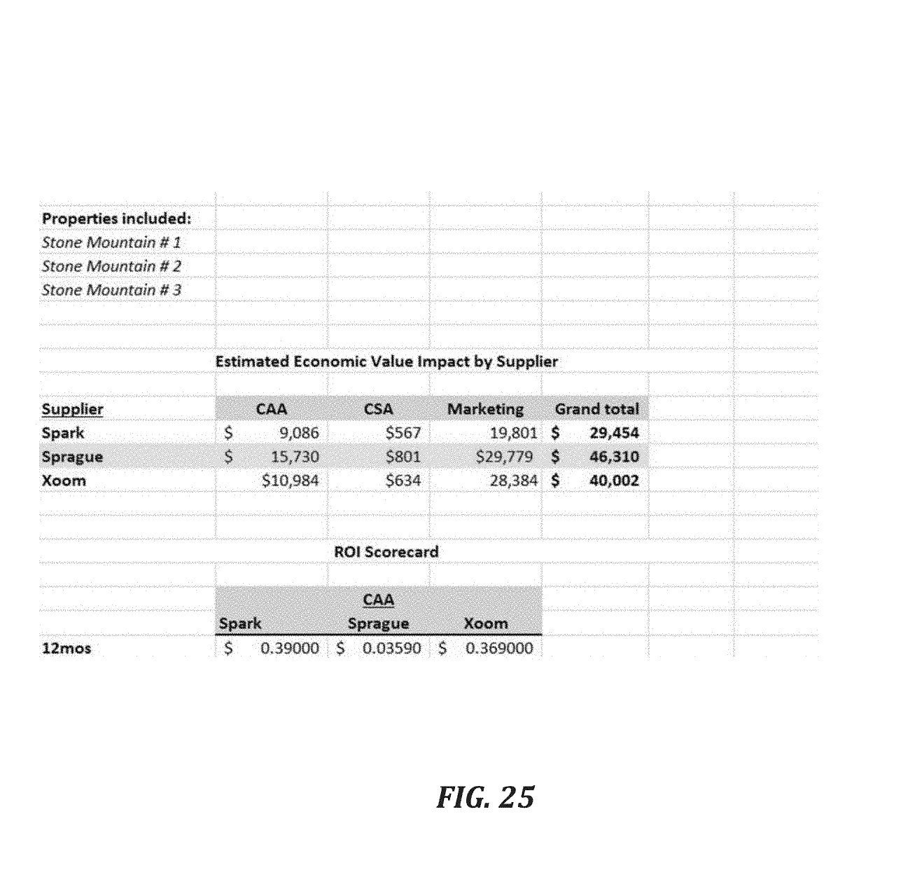

Further, in some embodiments, the online platform may be configured to provide an RFP bid intake data preview view as illustrated in FIG. 25. An RFP bid intake data preview view may facilitate the platform user in reviewing or interacting with the details of an RFP bid—this may include the capability of interacting with underlying RFP bid data in a granular way, e.g. with individual data-points. Further, this may include various forecasts, analyses, threshold determinations, economic impact estimates, features such as a return on investment (ROI) “scorecard,” and/or other details of an RFP bid.

An RFP bid intake data preview view can be browser-based (as with database data supplied to a platform user via a web interface), or it can be a downloadable file in spreadsheet (e.g. CSV, Microsoft Excel), database (e.g. SQL MDF, Microsoft ACCDB), list, graphical, proprietary or open-standard data object, or other format.

III. Platform Configuration

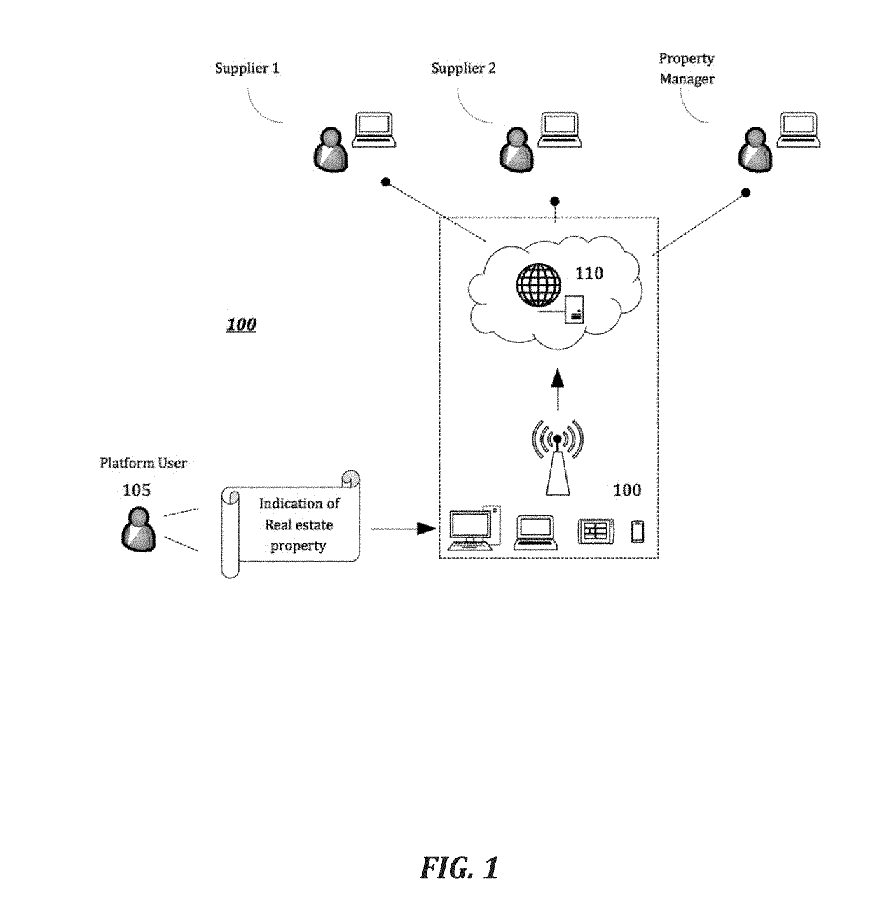

FIG. 1 illustrates one possible operating environment through which a platform consistent with embodiments of the present disclosure may be provided. By way of non-limiting example, an online platform 100 may be hosted on a centralized server 110, such as, for example, a cloud computing service. A user 105 may access platform 100 through a software application. Examples of the user 105 may include one or more of property owners, property managers, suppliers of products and/or services, vendors and contractors.

Accordingly, the online platform 100 may be accessible by platform users such as consumers of products and/or services related to real estate properties and providers of the products and/or services. As shown in FIG. 1, the online platform may be accessed by suppliers 1 and 2 operating a computer connected to the online platform over a communication network. Similarly, a property manager may also access the online platform by operating a computer connected to the online platform over a computer network.

Accordingly, the online platform 100 may present suitable user interfaces according to a type of the platform user. For example, when the platform user is a consumer such as a property manager, the online platform may present a user interface listing one or more real estate properties associated with the platform user. Additionally, the platform user may be allowed to select a real estate property and an associated product and/or service. Subsequently, the platform user may be presented with supplier information corresponding to the product and/or service. For instance, the supplier information may include bids from the different suppliers, contract periods and bid terms. Further, additional information such as market trends with regard to pricing of the product and/or service may be displayed to the platform user in order to enable information selection and acceptance of bids.

Further, in case the platform user is a supplier, the online platform may present a user interface including a listing of one or more property owners and/or real estate properties. Accordingly, when the supplier selects a property owner, one or more real estate properties associated with the property owner may be determined and presented to the supplier. Further, the supplier may be presented with an interface that enables the supplier to select a product and/or service for provisioning to a real estate property associated with the property owner. Accordingly, upon selecting a product and/or service, the supplier may be presented with an interface to place bids and bid terms for provisioning the product and/or service.

The software application may be embodied as, for example, but not be limited to, a website, a web application, a desktop application, and a mobile application compatible with a computing device 1300. One possible embodiment of the software application may be provided by the eBid eXchange™ suite of products and services provided by eBid Systems LLC.

As will be detailed with reference to FIG. 13 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

IV. Platform Operation

FIG. 12 is a flow chart setting forth the general stages involved in a method 1200 consistent with an embodiment of the disclosure for provisioning of products and/or services for real estate properties using platform 100. Method 1200 may be implemented using a computing device 1300 as described in more detail below with respect to FIG. 13.

Although method 1200 has been described to be performed by computing device 1300, it should be understood that, in some embodiments, different operations may be performed by different networked elements in operative communication with computing device 1300. For example, server 110 and/or computing device 1300 may be employed in the performance of some or all of the stages in method 1200. Moreover, server 110 may be configured much like computing device 1300 and, in some instances, be one and the same embodiment. Similarly, apparatus for provisioning of products and/or services for real estate properties may be employed in the performance of some or all of the stages in method 1200. The apparatus may also be configured much like computing device 1300.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 1200 will be described in greater detail below.

Method 1200 may begin at starting block 1205 and proceed to stage 1210 where computing device 1300 may present, using a processor, a user interface comprising indication of one or more real estate properties as illustrated, for instance, in FIG. 2. As an example, a property manager may be in charge of managing several properties located at different geographical locations. Accordingly, when the property manager access the online platform with appropriate credentials identifying the property manager, the one or more real estate properties may be determined and presented to the property manager.

From stage 1210, where computing device 1300 presents the indication of one or more real estate properties, method 1200 may advance to stage 1220 where computing device 1300 may receive, using a processor, a selection from a user of at least one of a product and a service corresponding to the real estate property. For example, the property manager may select a real estate property of interest from the one or more real estate properties associated with the property manager. Subsequently, the property manager may select a utility such as, water, electricity and natural gas in relation to the real estate property.

Once computing device 1300 receives selection of at least one of the product and the service in stage 1220, method 1200 may continue to stage 1230 where computing device 1300 may present, using a processor, an indication of one or more suppliers of at least one of the product and the service based on the selection. For example, subsequent to selecting the utility such as natural gas in relation to the real estate property, the method may include presenting a list of suppliers of natural gas.

In addition, in some embodiments, along with the one or more suppliers, additional information such as rates, contract periods, bids, bid terms etc. may be provided. Accordingly, in some embodiments, the method may further include presenting, using a processor, indication of the one or more real estate properties to at one or more suppliers of at least one of the product and the service. Subsequently, the method may include receiving, using a processor, one or more bids corresponding to at least one of the product and the service from the one or more suppliers.

Once computing device 1300 presents the one or more suppliers in stage 1230, method 1200 may then end at stage 1240.

V. Platform Architecture

The online platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the online platform 100 may be hosted on a centralized server, such as, for example, a cloud computing service. Although method 1200 has been described to be performed by a computing device 1300, it should be understood that, in some embodiments, different operations may be performed by different networked elements in operative communication with computing device 1300.

Embodiments of the present disclosure may comprise a system having a memory storage and a processing unit. The processing unit coupled to the memory storage, wherein the processing unit is configured to perform the stages of method 1200.

FIG. 13 is a block diagram of a system including computing device 1300. Consistent with an embodiment of the disclosure, the aforementioned memory storage and processing unit may be implemented in a computing device, such as computing device 1300 of FIG. 13. Any suitable combination of hardware, software, or firmware may be used to implement the memory storage and processing unit. For example, the memory storage and processing unit may be implemented with computing device 1300 or any of other computing devices 1318, in combination with computing device 1300. The aforementioned system, device, and processors are examples and other systems, devices, and processors may comprise the aforementioned memory storage and processing unit, consistent with embodiments of the disclosure.

With reference to FIG. 13, a system consistent with an embodiment of the disclosure may include a computing device, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300′s operation. In one embodiment, programming modules 1306 may include GUI modules, search and analytics module and charting modules. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and nonvolatile, removable and non-removable media implemented in any method or technology for storage of information, such as computer readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., server application 1320) may perform processes including, for example, one or more of method 1200′s stages as described above. The aforementioned process is an example, and processing unit 1302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

VI. Technical Advantages

Embodiments of the present disclosure may provide a plurality of advantages, including, but not limited to:

1. Time reduction through Workflow Automation—internal reduction of time to create RFP's from 90 days to 5 days;

2. Improves Accuracy of RFP data to prevent back and forth dialogue between Supplier and EnergyLink—meter, account #, Tax ID, Legal Entity Name, etc.;

3. Improves ability to make decisions in a short window where commodity prices are locked down for only 24 to 48 hours. This is accomplished through automated workflows to include signatures on contracts process;

4. Algorithms calculate NYMEX, Rocky Mountain Index and LMN Indexes for daily pricing;

5. Algorithm for Executive Overview Map calculates problems and expiring contracts at property level using user defined preference;

6. Improves ability to send and analyze multiple Suppliers Bids versus 1 or 2 today;

7. Algorithm to determine regulated cities and utilities within deregulated states reducing wasted time and bidding where opportunities don't exist;

8. Algorithm to determine Sales Tax Recovery Opportunities in States where sales tax is not allowed on electric and gas commodities;

9. Algorithm to determine expiring Letters of Authorization to discuss Usage with Suppliers and Utilities;

10. Ability to compare contracted rates versus RFP'd rates real time;

11. Ability to compare multiple Sustainability offers against property information real time;

12. Ability to compare Budget rates to contracted rates real time;

13. Ability to track contract expirations, costs, and trends against predetermined preferences;

14. Ability to auto-renew contracts based on predetermined preferences—Contract expiration date, total contract value, cost reduction minimum, and trend change;

15. Ability to monitor marketing fee penetration by property;

16. Ability to select a commodity/sustainability provider based on predetermined preferences; and

17. Track legal review of contract negotiations.

VII. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of provisioning at least one of a product and a service corresponding to a real estate property, the method comprising:
presenting, using a processor, a user interface comprising indication of at least one real estate property;
receiving, using a processor, a selection from a user of at least one of a product and a service corresponding to the real estate property; and
presenting, using a processor, an indication of at least one supplier of at least one of the product and the service based on the selection.

2. The method of claim 1, further comprising:
presenting, using a processor, indication of the at least one real estate property to at least one supplier of at least one of the product and the service; and
receiving, using a processor, at least one bid corresponding to at least one of the product and the service from the at least one supplier.

3. The method of claim 1, further comprising:
presenting, using a processor, an indication of at least one supplier of at least one of the product and the service, based on the selection.

4. The method of claim 1, further comprising:
presenting, using a processor, a user interface for selecting a real estate property associated with a customer.

5. The method of claim 1, further comprising:
weighting, using a processor, the at least one supplier of at least one of the product and the service based on the selection, based on economic data.

6. A method of automated RFP generation comprising:
receiving, using a processor, an indication to generate an RFP;
accepting, using a processor, RFP data from at least one of a platform user and a database containing relevant RFP data;
presenting, using a processor, a user interface comprising the ability to review RFP data;
presenting, using a processor, a user interface comprising the ability to transmit an RFP;
transmitting, using a processor, an RFP to one or more suppliers;
receiving, using a processor, any RFP bids transmitted by the one or more suppliers; and
presenting, using a processor, a user interface comprising the ability to review RFP bid data.

7. The method of claim 6, further comprising:
accepting, using a processor, RFP data selectable from at least one data category, the at least one data category comprising at least one of contract type data, real estate property list data, supplier data, customer name data, geographical data, contract expiration date data, and commodity type data.

8. The method of claim 6, wherein the indication to generate an RFP comprises:
determining, using a processor, that an RFP opportunity event is within sufficient temporal proximity to trigger the indication to generate an RFP.

9. The method of claim 6, wherein the user interface comprising the ability to review the RFP data further comprises the ability to edit RFP data.

10. The method of claim 6, further comprising:
generating, using a processor, an RFP data preview in the form of at least one of a web interface and a downloadable file.

11. The method of claim 6, wherein the user interface comprising the ability to review the RFP bid data further comprises the ability to edit RFP bid data.

12. The method of claim 6, further comprising:
generating, using a processor, an RFP bid data preview in the form of at least one of a web interface and a downloadable file

13. The method of claim 6, further comprising:
managing, using a processor, document status data regarding at least one of transmission, receipt, recipients, electronic signature status, signing date, due date, and RFP progress stage.

14. A system for provisioning at least one of a product and a service corresponding to a real estate property, the system comprising:
a user interface comprising one or more dashboards;
a user interface comprising customer data;
a user interface comprising supplier data;
a user interface comprising real estate property data; and
a user interface comprising RFP lifecycle management.

15. The system of claim 14, further comprising:
a user interface comprising sustainability data.

16. The system of claim 14, further comprising:
a user interface comprising a mapping function.

17. The system of claim 14, wherein the user interface comprising RFP lifecycle management further comprises the ability of a platform user to review and edit at least one of RFP data and RFP bid data.

18. The system of claim 14, wherein the user interface comprising RFP lifecycle management further comprises the ability to generate a data preview for at least one of an RFP and an RFP bid, wherein the data preview comprises at least one of a web interface and a downloadable file.

19. The system of claim 14, wherein the user interface comprising RFP lifecycle management further comprises a user interface that allows selection of at least one of contract type data, real estate property list data, supplier data, customer name data, geographical data, contract expiration date data, and commodity type data.

20. The system of claim 14, wherein the user interface comprising RFP lifecycle management further comprises generating, by a processor, an ROI scorecard.
